(19) United States
(12) Patent Application Publication
(10) Pub. No.: US 2026/0231226 A1
(43) Pub. Date: Aug. 6, 2026

(54) WTRU TRANSMISSION OF CELL WUS INDICATION WHEN CONFIGURED WITH A MUTING PATTERN

(71) Applicant: InterDigital Patent Holdings, Inc., Wilmington, DE (US)

(72) Inventors: Jaya Rao, Montreal (CA); Faris Alfarhan, Montreal (CA); Paul Marinier, Brossard (CA); Ananth Kini, Conshohocken, PA (US); Erdem Bala, East Meadow, NY (US); Moon IL Lee, Melville, NY (US); Ghyslain Pelletier, Montreal (CA); Janet Stern-Berkowitz, Little Neck, NY (US)

(73) Assignee: InterDigital Patent Holdings, Inc., Wilmington, DE (US)

(21) Appl. No.: 19/152,300

(22) PCT Filed: Feb. 13, 2024
(86) PCT No.: PCT/US2024/015606

§ 371 Date: Jul. 30, 2025

Related U.S. Application Data
(60) Provisional application No. 63/445,460, filed on Feb. 14, 2023.

(51) Int. Cl. H04W 74/0833; H04B 17/318; H04W 52/02

(52) U.S. Cl. CPC H04W 74/0833; H04B 17/328; H04W 52/0235

(57) ABSTRACT

A wireless transmit/receive unit (WTRU) may receive configuration information comprising one or more of a synchronization signal block (SSB) muting pattern, cell wake up signal (WUS) resources, and/or a reference signal received power (RSRP). The WTRU may measure a first set of non-muted SSBs associated with the SSB muting pattern. The WTRU may determine the measurements of each of the first set of non-muted SSBs are below the RSRP threshold. The WTRU may send a cell WUS indication based on the determination that the measurements of each of the first set of non-muted SSBs are below the RSRP threshold. The WTRU may receive a WUS response that indicates a second set of non-muted SSBs. The WTRU may measure the second set of non-muted SSBs. The WTRU may select an SSB, from the second set of non-muted SSBs based on the measurements of the second set of non-muted SSBs.

### CROSS REFERENCE TO RELATED APPLICATION

This application claims priority to U.S. Provisional Patent Application No. 63/445,460 filed Feb. 14, 2023, the entire contents of which are incorporated herein by reference.

### BACKGROUND

A network may consume energy when not transmitting from other activities such as baseband (digital) processing for reception or beamforming. Therefore, subsequent generation systems may introduce power saving enhancements to reduce power consumption. For example, a wireless transmit/receive unit (WTRU) may be configured with cell discontinuous transmission (DTX)/discontinuous reception (DRX) pattern to indicate a duration of time over which a configured cell DRX pattern is active or inactive. A WTRU may determine to transmit and/or receive on certain resources depending on a network availability state. The WTRU may transmit a request to the network to modify the availability state to a state for which resources that would satisfy WTRU one or more requirements that are available.

### SUMMARY

Systems, methods, and apparatuses are provided herein with respect to procedures and/or behaviors for WTRUs operating in Network Energy Saving (NES) cells. Procedures and/or behaviors may include downlink (DL) synchronization with NES/Discontinuous transmission (DTX) cells, beam search and/or (re)selection with NES/DTX cells, and/or transmission of Cell wake-up signal (WUS) and/or uplink (UL) indication to NES cells.

Systems, methods, and apparatuses may include a WTRU that determines whether to transmit an UL indication to trigger synchronization signal block (SSB) transmission based on DL synchronization achieved with signals/beams received in cell NES/DTX state.

Systems, methods, and apparatuses may include a WTRU that determines whether to transmit Cell WUS indication when a limited and/or reduced number of SSBs are received according to a SSB muting pattern based on DL synchronization achieved with the non-muted SSBs.

Systems, methods, and apparatuses may include a WTRU that determines to transmit a Cell WUS indication to request to change an existing SSB muting pattern and/or for activating a new SSB muting pattern.

Systems, methods, and apparatuses may be provided herein with respect to WTRU transmission of Cell WUS indication when configured with a muting pattern. The WTRU may receive configuration information. The configuration information may indicate one or more of a SSB muting pattern, one or more Cell WUS resources, or a reference signal received power (RSRP) threshold.

The WTRU may, on a condition that the one or more measurements of the non-muted SSBs are below the RSRP threshold, perform one or more of the following. The WTRU may select a first SSB of the non-muted SSBs based on the one or more measurements. The WTRU may transmit a cell wake-up signal (WUS) to the first SSB. The WTRU may receive a WUS response from the first SSB. The WTRU may monitor for one or more second SSBs based on the WUS response. The WTRU may select a third SSB from the one or more second SSBs. The WTRU may transmit a Random Access Channel (RACH) message based on the selected second SSB.

The SSB muting pattern may indicate which SSBs are muted in one or more (e.g., each) burst(s). The SSB muting pattern may include eight (8) non-muted SSBs per burst with periodicity 20 milliseconds (ms). The SSB muting pattern may include four (4) non-muted SSBs per burst with periodicity 40 ms.

The WUS may include one or more of an index to the one or more second SSBs, a muting disabled indication, an uplink grant, a network energy savings (NES) state identifier (ID) and/or one or more (e.g., another) SSB muting pattern(s).

A WTRU may receive configuration information. The configuration information may include a SSB muting pattern, one or more cell WUS resources, and/or an RSRP threshold. The SSB muting pattern may include a periodicity, a start offset of an SSB burst, and/or number of SSBs per burst. The SSB muting pattern may indicate which SSBs are muted or not muted in each of a plurality of SSB bursts. The non-muted SSBs in consecutive bursts may be the same. The cell WUS resources may include a mapping associated with non-muted SSBs and/or WUS resources. The WTRU may measure a first set of non-muted SSBs associated with the SSB muting pattern. The WTRU may determine that measurements of each of the first set of non-muted SSBs are below the RSRP threshold. The WTRU may send a cell WUS indication based on the determination that the measurements of each of the first set of non-muted SSBs are below the RSRP threshold. The WTRU may receive a WUS response that indicates a second set of non-muted SSBs. The WTRU may measure the second set of non-muted SSBs. The WTRU may select an SSB from the second set of non-muted SSBs based on the measurements of the second set of non-muted SSBs. The SSB may be selected for transmission of a RACH preamble.

The WUS response may be received subsequent to sending the cell WUS. The WTRU may be configured to trigger the measurement of the first set of non-muted SSBs based on a random access (RA) event. The cell WUS indication may be sent using resources associated with an SSB of the first set of non-muted SSBs. The selected SSB may be associated with a measured RSRP that is a highest RSRP associated with the second set of SSBs. The WTRU may send a random access message based on the selected SSB. The random access message may be associated with initial access and establishment of a connection with the network. For example, the WTRU may transmit an initial access message using one or more RACH resources associated with the selected SSB. The indication of the second set of non-muted SSBs may include one or more of an indication of one or more newly available SSBs and/or a second SSB muting pattern.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example of a WTRU that may be configured to achieve downlink (DL) synchronization with discontinuous transmission (DTX) of synchronization signal blocks (SSBs) based on a DTX SSB transmission pattern.

FIG. 3 is a system diagram illustrating an example of a WTRU that may be configured to achieve DL synchronization with non-muted SSBs based on an SSB muting pattern.

FIG. 4 is a diagram illustrating an example expansion of a SSB muting pattern.

### DETAILED DESCRIPTION

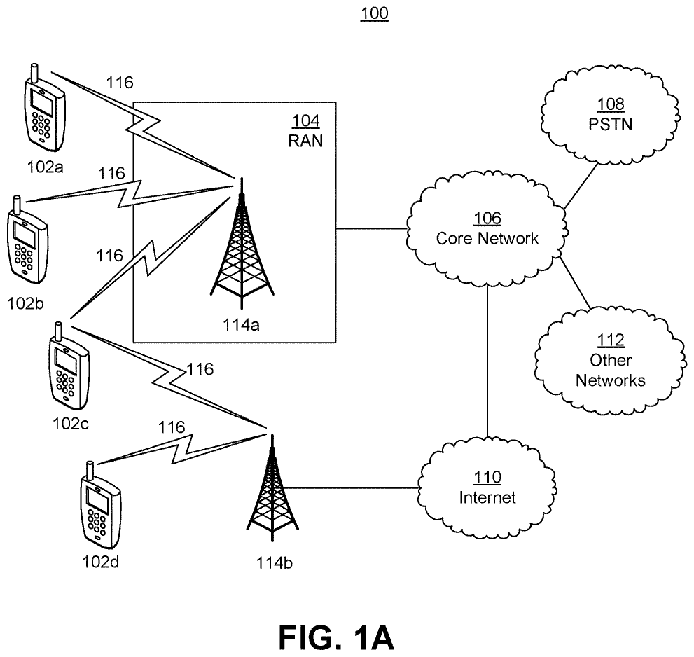

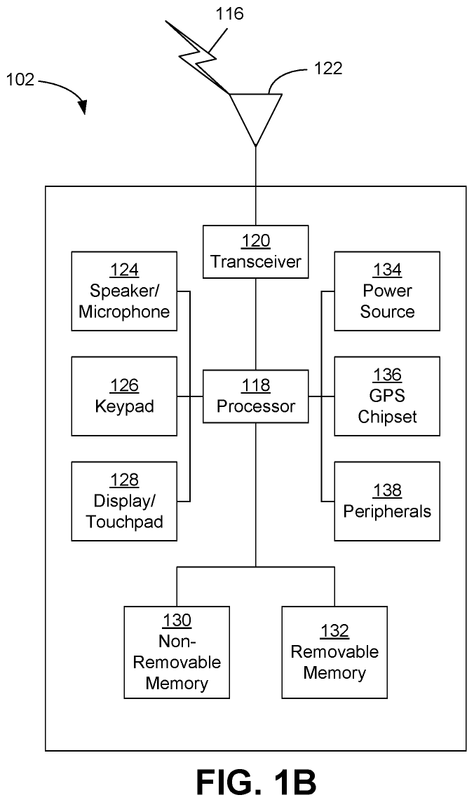

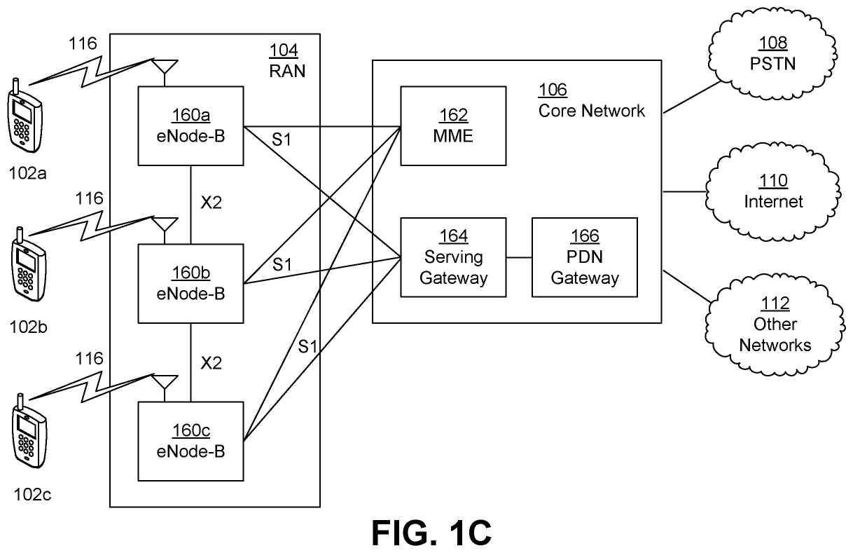

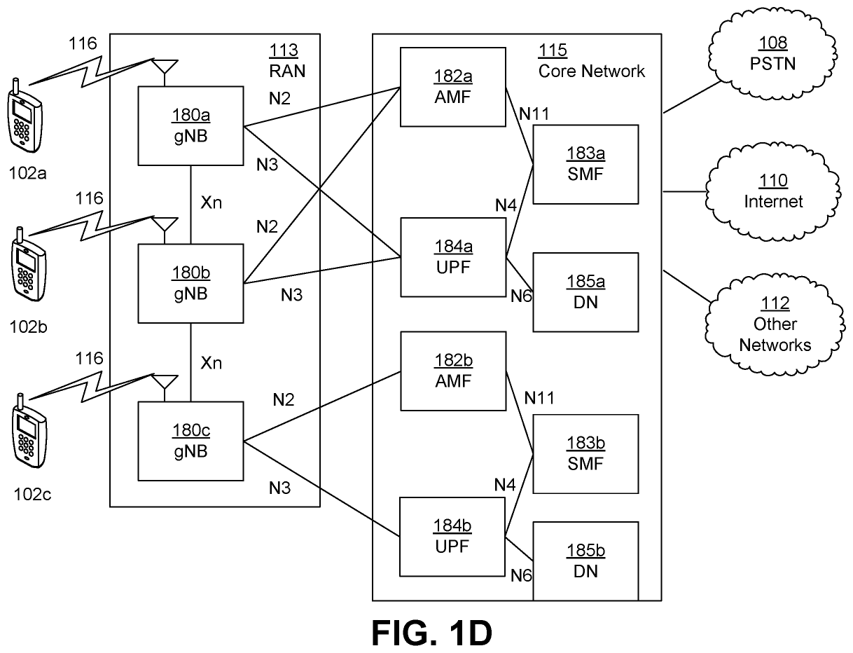

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

3GPP RAN may include one or more studies with respect to network energy savings. The one or more studies may include enhancements enabling the network to minimize its power consumption from transmission and/or reception. Such minimization may be beneficial for reducing operational costs and/or environmental sustainability.

Compared to earlier systems, the design of NR of legacy systems/architecture (e.g., as described in Rel-15), may be significantly (e.g., very) efficient from the perspective of minimizing transmissions from the network when there is no data. For example, always-on cell-specific reference signal (CRS) may not be used in NR. In examples, there may be potential still for energy consumption reduction. For example, the network may still consume energy when not transmitting from other activities such as baseband (e.g., digital) processing for reception and/or beamforming. Such power (e.g., idle power) consumption may not be negligible in dense networks even when no WTRU is served during a given period. If the network could turn off these one or more activities when not transmitting to a WTRU, energy consumption may be reduced.

Unlike LTE, NR may not include transmission of always-on synch and/or reference signals and/or supports adaptable bandwidth and/or MIMO capabilities. Adaptation of network resources may not impact legacy WTRU. Adaptation of network resources may enable higher (e.g., greater) efficiency in operating additional/enhanced (e.g., newer) deployments and/or subsequent (e.g., later) generations.

The following terminology may be used herein.

The term Synchronization Signal Block and/or SS/Physical Broadcast Channel (PBCH) block may include one or more of the following: Primary Synchronization Signal (PSS); Secondary Synchronization Signal (SSS); Physical Broadcast Channel PBCH (Data, MIB) and PBCH (DMRS). The one or more SSBs may be transmitted by the base station in different directions as beams. The number of SSB beams in an SSB burst set may depend on the carrier frequency. For example, an SSB burst may include 4 SSBs for FR1 (<3 GHz), 8 SSBs for FR1 (3 to 6 GHz) and 64 SSBs for FR2. An SSB burst set may be transmitted periodically within an interval (e.g., 5 milliseconds (ms)).

The term System Information (SI) may include one or more Master Information Block (MIB) and/or one or more System Information Blocks (SIBs). The WTRU may receive the MIB on the broadcast channel (BCH) with a certain periodicity (e.g., 80 ms) and/or with one or more (e.g., some) repetitions (e.g., within 80 ms). The MIB may include certain parameters that are needed to acquire SIB 1 from the cell. The first transmission of the MIB may be scheduled in certain subframes and/or repetitions may be scheduled according to the period of the SSB. The SIB1 may be referred to as remaining minimum SI (RMSI). The SIB1 may be received on the DL shared channel (DL-SCH) with certain periodicity (e.g., 160 ms) and/or with variable transmission repetition periodicity (e.g., within 160 ms). SIB 1 may include information regarding the availability and/or scheduling (e.g., mapping of SIBs to SI message, periodicity, SI-window size) of other SIBs with an indication whether one or more SIBs may be (e.g., only) provided on-demand. If the SIBs are provided (e.g., only) on-demand, the SIB1 may include the identifiers/indexes associated with the SIBs that the WTRU may indicate in the on-demand SI request. The SIB1 may be cell-specific SIB. Other SIBs (e.g. SIB2, SIB3, positioning SIBs (posSIBs)) may be carried in (SI) messages. Other SIBs (e.g. SIB2, SIB 3, posSIBs) may be received on the DL-SCH. SIBs and/or posSIBs having the same periodicity may be mapped to the same SI message. Any SIB and/or posSIB except SIB1 may be configured to be cell specific and/or area specific. For example, any SIB and/or posSIB except SIB1 may be configured to be cell specific by using an indication in SIB1. The cell specific SIB may be applicable (e.g., only) within a cell that provides the SIB. The area specific SIB may be applicable within an area. The area may be referred to as SI area. The SI area may include one or several cells and/or may be identified by systemInformationAreaID.

The term channel state information (CSI) may include one or more of the following: channel quality index (CQI), rank indicator (RI), precoding matrix index (PMI), an L1 channel measurement (e.g., RSRP such as L1-RSRP, or SINR), CSI-RS resource indicator (CRI), SS/PBCH block resource indicator (SSBRI), layer indicator (LI) and/or any other measurement quantity measured by the WTRU from the configured CSI-RS and/or SS/PBCH (SSB) block.

The term Uplink control information (UCI) may include one or more of the following: Hybrid Automatic Repeat Request (HARQ) feedback for one or more HARQ processes, Scheduling request (SR), Link recovery request (LRR), Configured grant or cell group (CG)-UCI and/or other control information bits that may be transmitted on the physical uplink control channel (PUCCH) and/or physical uplink shared channel (PUSCH).

The phrase channel conditions may include any conditions relating to the state of the radio/channel. The state of the radio/channel may be determined by the WTRU from one or more of the following: a WTRU measurement (e.g., L1/SINR/RSRP, CQI/MCS, channel occupancy, received signal strength indicator (RSSI), power headroom, exposure headroom), L3/mobility-based measurements (e.g., RSRP, reference signal received quality (RSRQ), s-measure), a radio link monitoring (RLM) state, and/or channel availability in unlicensed spectrum (e.g., whether the channel is occupied based on determination of a listen-before-talk (LBT) procedure or whether the channel is deemed to have experienced a consistent LBT failure).

A Physical Random Access Channel (PRACH) resource may include one or more of the following: a PRACH resource (e.g., in frequency), a PRACH occasion (RO) (e.g., in time), a preamble format (e.g., in terms of total preamble duration, sequence length, guard time duration and/or in terms of length of cyclic prefix) and/or a certain preamble sequence used for the transmission of a preamble in a random access procedure.

A property of scheduling information (e.g., an uplink grant or a downlink assignment) may include one or more of the following: a frequency allocation; an aspect of time allocation (e.g., duration); a priority; a modulation and/or coding scheme; a transport block size; a number of spatial layers; a number of transport blocks to be carried; a Transmission configuration indicator (TCI) state or Sounding Reference Signal (SRS) resource indicator (SRI); a number of repetitions; and/or whether the grant may be configured grant type 1, type 2 and/or a dynamic grant.

An indication (e.g., by downlink control information (DCI) may include one or more of the following: An explicit indication by a DCI field or by radio network temporary identifier (RNTI) used to mask cyclical redundancy check (CRC) of the physical downlink control channel (PDCCH). An implicit indication by a property such as DCI format, DCI size, Coreset or search space, aggregation level, identity of first control channel resource (e.g., index of first control channel element (CCE)) for a DCI, where the mapping between the property and the value may be signaled by RRC or MAC. An explicit indication by a DL MAC CE.

The terms network, cell, base station and/or gNB may be used interchangeably herein.

The terms SSBs and/or beams may be used interchangeably herein.

The terms network availability state, cell DTX mode/configuration, and/or NES state may be used interchangeably herein.

Systems, methods, and apparatuses may be provided herein with respect to Cell DTX and/or Cell Discontinuous Reception (DRX).

The gNB may (e.g., currently) use reduced downlink transmission/uplink reception activity without an explicit cell DTX/DRX pattern with restrictions due to WTRU DRX configurations and/or any configured transmission/reception (e.g., common channels/signals). Connected Mode DRX (C-DRX) may be configured per WTRU. The alignment of the DRX cycles and/or offsets for different WTRUs may be done via RRC. During WTRU DRX off period, the WTRU may not expect to monitor PDCCH, but the WTRU may initiate UL transmission according to the configured resources (e.g., using PUCCH, RACH, SR, and/or CG-PUSCH). Aligning and/or omitting of DRX patterns across multiple WTRUs may be achieved via gNB implementation.

Cell DTX/DRX may aim to provide one or more mechanisms informing the WTRU whether the cell stays inactive. This may include enhancements to WTRU DRX configuration (e.g., to align/omit DRX cycles and/or start offsets of DRX, for WTRUs in connected mode or idle/inactive mode, potentially allowing longer opportunities for cell inactivity). During a cell DTX/DRX, for example, the cell may have a reduced (e.g., no) transmission/reception or (e.g., only) keep limited transmission/reception. For example, the cell may not transmit and/or receive one or more (e.g., some) periodic signals/channels (e.g., common channels/signals and/or WTRU specific signals/channels).

Cell DTX/DRX may be applied to one or more WTRUs in RRC_CONNECTED state. A periodic Cell DTX/DRX (e.g., active and non-active periods) may be configured by gNB via WTRU-specific RRC signaling per serving cell. Cell DTX/DRX mode may be activated/de-activated via dynamic L1/L2 signaling and/or WTRU-specific RRC signaling. Both WTRU specific and common L1/L2 signaling may be considered for activating/deactivating the Cell DTX/DRX mode. Cell DTX and/or Cell DRX modes may be configured and/or operated separately (e.g., one RRC configuration set for DL and/or another for UL).

Additionally or alternatively, Cell DTX/DRX may be configured and/or operated together. One or more of the following parameters may be configured per Cell DTX/DRX configuration: periodicity, start slot/offset, and/or on duration. Additionally or alternatively, Cell DTX indication may be part of SI update and/or SIB signaling. There may be a common time for one or more (e.g., all) WTRUs to determine cell DTX status.

Systems, methods, and apparatuses may be provided herein with respect to Network Availability States, Cell DTX mode, and/or NES states.

A WTRU may determine to transmit and/or receive on one or more resources. The WTRU may determine whether to transmit and/or receive on certain resources depending on a network availability state, which may imply the gNB's power savings status. An availability state may correspond to a network energy savings state, a cell DTX mode, a cell DRX mode, and/or a gNB activity level. An availability state may be uplink or downlink specific, and/or may change from symbol to symbol, slot to slot, frame to frame, and/or on longer duration granularity. The availability state may be determined by the WTRU and/or indicated by the network. An availability state may be, for example, On, DL and UL active, UL only active, off, reduced Tx power, dormant, micro sleep, light sleep, and/or deep sleep. Such states can be abstracted by one or more network (NW) configuration parameters and/or values. Dynamic indication may point to the active availability state (e.g., by DCI or MAC CE signaling). The Off availability state may imply that the gNB's baseband hardware is (e.g., completely) turned off. The sleep availability state may imply that the gNB wakes up periodically to transmit certain signals (e.g., presence signals, synchronization, and/or reference signals) and/or receive certain UL signal(s). In one or more (e.g., some) availability states, one or more (e.g., some) DL and/or UL resources may not be available during certain periods of time.

Unavailability of DL and/or UL resources may enable the network to turn off baseband processing and/ other activity(ies). One or more (e.g., some) measurement resources (e.g., SSBs and/or CSI-RS) may (e.g., only) be made available in certain availability states, including one or more of the following: RLM, beam failure detection (BFD), radio resource management (RRM) measurements, CSI-RS feedback configuration, and/or a different power offset for CSI feedback.

Under certain conditions, for example, the WTRU may further transmit a request to the network (e.g., wake-up request and/or wake-up signal/indication) to modify the availability state to a state for which one or more resources that would satisfy WTRU requirements are available.

The WTRU may determine an availability state from reception of availability state indication from, for example, by L1/L2 signaling (e.g., a group common DCI or indication), and/or may implicitly determine an availability state from the reception of periodic DL signaling-or lack thereof.

The WTRU may determine if a resource is available for transmission/reception and/or measurements for the determined network availability state if the resource is applicable in the active availability state. Additionally or alternatively, the WTRU may adapt its active C-DRX cycle, active spatial elements (e.g., antenna and/or logical ports), active transmission/reception points (TRPs), paging occasions as a function of the signaled and/or determined availability state. The WTRU may be configured with one or more sets of NES transmission and/or reception parameters per availability state (e.g., by broadcast or dedicated configuration signaling). The WTRU may apply the NES parameter set according to the determined or signaled availability state. The WTRU may apply one or more applicable configurations depending on the determined NES state. A set of NES parameters may include one or more of the following: one or more (e.g., a number) of antenna ports, a C-DRX configuration, a measurement configuration (e.g., for RRM, RLM, and/or BFD), CSI feedback, a CSI-RS configuration, an SSB configuration, conditional handover (CHO) or mobility candidates, and/or a set of active TRPs.

An availability state may be applicable to one or more transmissions, receptions, and/or measurement resources. An availability state may be applicable to one or more time period such as a time slot and/or time symbol. An availability state may be applicable to a serving cell, a cell group, a frequency band, a bandwidth part, a TRP, a set of spatial elements, and/or a range of frequencies within a bandwidth part. For example, when an NES state changes in a cell, the WTRU may receive an availability state change indication indicating that this change is just for that cell, for one or more (e.g., all) cells at the same frequency, and/or the same RAT.

The WTRU may consider the active availability state associated with a cell, carrier, TRP, and/or frequency band to be Off, Deep sleep, or Micro sleep based on (e.g., after) reception of a DL signaling that changes the cell's and/or TRP's availability state. For example, the WTRU may receive a turn off command on broadcast signaling, RRC signaling, DCI (e.g., a group common DCI), and/or a DL MAC CE (e.g., indication part of physical downlink shared channel (PDSCH)). The WTRU may determine an availability state from reception of availability state indication from, for example, by L1/L2 signaling (e.g., a group common DCI or indication) and/or broadcast signaling associated with an availability state. For example, an availability state change indication may also, or alternatively, be part of SI update and/or SIB signaling (e.g., in a separate SIB that is not read by legacy WTRUs). There may be a common time for one or more (e.g., all) WTRUs in the cell to determine availability state status.

The WTRU may implicitly determine (e.g., assume) a certain availability state associated with a cell, carrier, TRP, and/or frequency band (e.g., “Off, ”deep sleep“, ”micro sleep“ or dormant”). For example, the WTRU may implicitly determine a certain availability state from: Reception of a paging message (e.g., paging DCI, paging PDSCH, or a paging related signal, e.g., PEI); the gNB DTX status (e.g., whether the gNB is in active time or an associated activity timer is running); lack of detection of a presence indication; the availability state of an associated cell; and/or measured channel conditions(s) being below, or above, a threshold.

The WTRU may be configured to monitor an indication that may characterize the level of network activity (e.g., an availability state). The network activity may be associated with a gNB and/or a cell. The WTRU may determine (e.g., assume) the same availability state for one or more (e.g., all) cells part of the same gNB (e.g., cells of the same MAC entity). The network activity indication (e.g., the presence indication) may include a channel (e.g., a PDCCH) and/or a signal (e.g., a sequence). The activity indication and/or the NES state change indication/command (e.g., referred to as cell activity indication) may indicate the level of activity the WTRU may expect from the associated gNB and/or cell, e.g., reduced activity. The activity indication may include activity information of other gNBs/cells. The activity indication may be a PDCCH and/or may include group common signaling. For example, the NW may transmit a group common DCI to a group of WTRUs (e.g., WTRUs in the serving cell) indicating a change of an activity state and/or activity level in UL and/or DL. The CRC of the PDCCH may be scrambled with a dedicated activity indication RNTI or an NES-RNTI. A WTRU may be configured with one or more search spaces associated with the monitoring occasions of the activity indication PDCCH. The indication may include a go-to-sleep signal, e.g., a predefined sequence. When the WTRU detects this sequence, for example, the WTRU may expect a reduced activity level over a specific time duration. The WTRU may activate C-DRX for the period of time indicated. Additionally or alternatively, two or more sequences may be used to indicate regular activity and/or reduced activity.

The signaling within the PDCCH and/or the activity indication may include one or more of the following: expected activity level of the associated gNBs/cells over a specific time interval (e.g., an availability state); for one or more (e.g., each) activity level(s) (e.g. availability state), transmission and/or reception attributes may be defined; A set of configurations may be associated with an activity level and/or may be used/applied when that activity level is indicated (e.g., an NES parameter set); the time interval over which an activity level is determined (e.g., assumed) may be signaled in the PDCCH and/or part of the activity indication; and/or the time interval over which an activity level is determined (e.g., assumed) may be predetermined.

Expected activity level of the associated gNBs/cells over a specific time interval (e.g., an availability state) may include the activity levels being predetermined and/or configured and may, for example, include regular and/or reduced activity. The signaling may indicate the activity level. For example, bit 1 may indicate regular activity and bit 0 may indicate reduced activity.

For one or more (e.g., each) activity level(s) (e.g., availability state), transmission and/or reception attributes may be defined. For example, during reduced activity, the WTRU may not be expected to monitor certain PDCCH search spaces (e.g., including all SSs), and/or receive a certain type of PDSCH (e.g., including all PDSCH), and/or transmit PUCCH/PUSCH, and/or perform certain measurements. The WTRU may start or stop monitoring PDCCH and/or TCI states associated with determined NES state, including PDCCH resources or TCI states associated with (de)activated TRPs or spatial elements.

A set of configurations (e.g., SS configurations, CSI reporting configurations, indices of transmitted SSBs, etc.) may be associated with an activity level and/or may be used/applied when that activity level is indicated (e.g., an NES parameter set). One or more (e.g., each) set(s) of configurations may have an attribute associated with an activity level (e.g., a tag that can be set to “reduced activity”).

The time interval over which an activity level is determined (e.g., assumed) may be signaled in the PDCCH and/or part of the activity indication. The time interval may be indicated using a bitmap where one or more (e.g., each) bit(s) in the bitmap may be associated with a specific duration, e.g., a slot or a frame. For example, bit 1 may indicate regular activity and bit 0 may indicate reduced activity on an associated frame. The time interval may be indicated with a start time and length of interval. The start time may be defined (e.g., as described herein). For example, the start time may be determined by adding a fixed offset to the time the indication is received. The length of the interval may be configured and/or signaled in the indication PDCCH.

The time interval over which an activity level is determined (e.g., assumed) may be predetermined. The WTRU may determine (e.g., assume) an interruption delay (e.g., or more generally a time till the NES state changes) based on (e.g., after) the NES state change command reception (e.g., after the last symbol or slot on which the command was received). The interruption time may be in absolute time, a number of symbols, or a number of slots.

The WTRU may determine that an uplink and/or downlink resource and/or signal is available for transmission/reception and/or measurements for the determined network availability state if the uplink and/or downlink resource(s) and/or signal(s) is/are applicable in the active availability state. The WTRU may determine that a subset of measurement resources and/or signals (e.g., SSBs, CSI-RS, TRS, PRS) are not applicable in certain availability states. The WTRU may determine that a subset of uplink and/or downlink resources (e.g., PRACH, PUSCH, PUCCH) are not applicable in certain availability states. The WTRU may transmit one or more (e.g., some) uplink signals (e.g., only) in a subset of NW availability states (e.g., SRS, positioning SRS, PRACH, UCI).

Achieving DL synchronization when a limited SSBs/SIBs are transmitted by the base station (e.g., using different transmission/muting patterns and/or periodicities) may be one problem addressed by one or more of the embodiments disclosed herein. Triggering one or more (e.g., any) UL transmission(s) (e.g., Cell WUS, RACH preamble, SR) with reduced delay when there are limited or no SSBs/SIBs, beams, and/or CSI-RS may be one problem addressed by one or more of the embodiments disclosed herein.

When a base station/cell is operating in an NES state/mode (e.g. cell DTX, cell DRX or dormant state), the DL beams, such as SSB/SIB and/or CSI-RS may be transmitted and/or may be transmitted less frequently (e.g., with periodicity of >160 ms). This may result in delays during DL synchronization, beam search/selection, initial access, on-demand SI, failed UL transmissions during the cell DRX active durations, etc.

The WTRU may transmit a wake-up request indication (e.g., Cell-WUS indication, RACH preamble) for requesting the cell to transition to a different NES state and/or to increase the periodicity of SSB/SIBs and/or CSI-RS. The transmission of such wake-up request indication and/or the subsequent change in the cell's NES state may (e.g., allow to) reduce the delay(s) associated with accessing the cell for any subsequent transmissions/receptions of signaling/data. In examples, it may not be effective for the WTRU to transmit a wake-up request indication using outdated DL/UL beam pairs and/or without performing resynchronization with the latest DL beams. This is because the strongest (e.g., best) DL/UL beam pairs (e.g., identified prior to cell DTX) and/or any of the configurations and/or resources associated with the beam pairs may not be valid and/or may have changed since the gNB transitioned into the NES state (e.g., cell DTX).

Systems, methods, and apparatuses are provided herein with respect to a WTRU that synchronizes with NES/DTX SSBs based on (e.g., before) transmitting SR. A WTRU may receive configuration information (e.g., when the cell transitions to cell DTX mode). Configuration information may include Cell WUS resources (e.g., mapping between DTX SSBs and Cell WUS resources). For example, the set of DTX SSBs compared with the set of non-DTX SSBs may be a smaller set, may be transmitted less often, may include PSS and SSS, and/or may not include PBCH. Configuration information may include SR resource associated with a reference SSB beam (e.g., last beam associated with WTRU before cell DTX). Configuration information may include a timing advance (TA) time duration. Configuration information may include WUS response duration. Configuration information may include beam validity time duration. Additionally or alternatively, the WTRU may start the TA timer. Additionally or alternatively, the WTRU may start the beam validity timer. The WTRU may initiate monitoring of DTX SSBs (e.g., wide beams), for example, when triggered by an SR event such as the WTRU has data to transmit. The WTRU may select a DTX SSB, for example, based on one or more measurements. The WTRU may transmit Cell WUS using one or more resources associated with the selected DTX SSB. For example, the WTRU may transmit the Cell WUS if or when (e.g., only if or when) the TAT is not expired. For example, the WTRU may transmit the Cell WUS if or when the beam validity timer (e.g., or the Timing alignment timer (TAT)) is expired. The WTRU may start a WUS response timer and/or monitor for a WUS response. For example, the WUS response may include one or more of: a PUCCH resource, and/or index(es) for one or more new SSBs (e.g., new SSBs may include one or more of the following: non-DTX SSBs, SSBs different from or in addition to the DTX SSBs, other SSBs that may have been activated and/or may now be available). If the WUS response is received based on (e.g., before) the expiry of the response timer, the WTRU may perform one or more of the following: monitor for new SSBs (e.g., SSB beams); select a new SSB (e.g., based on measurements); transmit a RACH preamble associated with a selected new SSB; receive (e.g., in RAR) the configuration information (e.g., PUCCH resource for SR) of the selected new SSB; and/or transmit SR via the selected new SSB. If the WUS response is not received and/or the response timer expires, the WTRU may retransmit the one or more Cell WUS indications (e.g., for N attempts before termination). If the TAT has expired, the WTRU may transmit a RACH preamble to the cell associated with the selected DTX SSB. The WTRU may not send the Cell WUS. If the beam validity timer (e.g., or the TAT) has not expired and/or an SR is pending and/or an SR event occurs, the WTRU may perform one or more of the following: transmit SR using the configured resource(s); receive PUSCH resource(s) for Buffer status report (BSR) in DCI; and/or transmit BSR using the PUSCH resource.

Systems, methods, and apparatuses are provided herein with respect to a WTRU that may transmit a Cell WUS indication to wake up one or more muted SSBs when configured with an SSB muting pattern. A WTRU may receive configuration information. The configuration information may include an SSB muting pattern (e.g., periodicity, start offset of SSB burst, number of SSBs per burst, etc.); one or more cell WUS resources (e.g., mapping between with non-muted SSBs and WUS resources); and/or a RSRP threshold. An SSB muting pattern may include, for example, 8 non-muted SSBs per burst with periodicity 20 ms and/or 4 non-muted SSBs per burst with periodicity 40 ms. An SSB muting pattern may indicate which SSBs (e.g., which SSB indexes) are muted or not muted in one or more (e.g., each) burst(s), and/or where the SSBs available (e.g., not muted) in consecutive bursts may be the same or different. For example, the SSB muting pattern may indicate which SSBs are muted or not muted in each of a plurality of SSB bursts. Non-muted SSBs in consecutive bursts may be the same. The SSB muting pattern may be a pattern from a set of configured patterns and/or may be indicated by a pattern ID and/or index. Additionally or alternatively, the WTRU may receive an indication and/or configuration information indicating that SSB muting is enabled. The SSB muting pattern ID may be received when the SSB muting is enabled (e.g., in the same message, DCI and/or MAC-CE).

The WTRU may perform one or more measurements on the available non-muted SSBs within the SSB muting pattern, for example, when triggered by an event (e.g., need to connect, resume a connection, and/or transmit data). For example, the WTRU may measure a first set of non-muted SSBs associated with the SSB muting pattern. The WTRU may be configured to trigger the measurement of the first set of non-muted SSBs based on a random access (RA) event, as described herein. The WTRU may determine that one or more measurements of each of the first set of non-muted SSBs are below the RSRP threshold. The WTRU may select a first SSB from among the non-muted SSBs (e.g., based on measurements), for example, if the RSRP measurements of the non-muted SSBs are below a RSRP threshold. The WTRU may transmit a Cell WUS (e.g., a cell WUS indication) using resources associated with the selected non-muted SSB, for example, if the RSRP measurements of the non-muted SSBs are below a RSRP threshold. For example, the Cell WUS may be intended to wake up one or more (e.g., some) muted SSBs (e.g., adjacent to the selected non-muted SSB). For example, the WTRU may send a cell WUS indication based on the determination that the measurements of each of the first set of non-muted SSBs are below the RSRP threshold. The cell WUS indication may be sent using one or more resources associated with an SSB of the first set of non-muted SSBs. The WTRU may receive a WUS response, via one or more resources associated with the selected non-muted SSB, for example, if the RSRP measurements of the non-muted SSBs are below a RSRP threshold. For example, WUS-response may include one or more of the following: index to SSBs (e.g., other SSBs that may have been activated and/or may now be available), indication of disabling of muting, UL grant, NES state ID, and/or new muting pattern (e.g., pattern ID). For example, the WUS response may indicate a second set of non-muted SSBs. The indication of the second set of non-muted SSBs may include one or more of an indication of one or more newly available SSBs and/or a second SSB muting pattern. The WUS response may be received subsequent to sending the cell WUS indication. If the RSRP measurements of the non-muted SSBs are below a RSRP threshold, the WTRU may monitor for SSBs based on the information in WUS response (e.g., newly available SSBs, new muting pattern). For example, the WTRU may measure the second set of non-muted SSBs. If the RSRP measurements of the non-muted SSBs are below a RSRP threshold, the WTRU may select a second SSB (e.g., a new beam) from the monitored SSBs (e.g., based on one or more measurement(s)). For example, the WTRU may select an SSB from the second set of non-muted SSBs based on the measurements of the second set of non-muted SSBs. The SSB may be selected for transmission of a RACH preamble. The selected SSB may be associated with a measured RSRP that is a highest RSRP associated with the second set of SSBs. If the RSRP measurements of the non-muted SSBs are below a RSRP threshold, the WTRU may transmit a random access message (e.g., RACH Msg1 and/or Msg3) based on (e.g., using a resource associated with) the selected second SSB (e.g., new beam). The random access message may be associated with initial access and establishment of a connection with the network (e.g., as described herein). For example, the WTRU may select a RACH preamble associated with the selected second SSB (e.g., new beam) and/or transmit the preamble (e.g., Msg1). For example, if the WUS response includes an UL grant, the WTRU may transmit the Msg3 (e.g., RRC message) based on the selected second SSB (e.g., new beam).

Systems, methods, and apparatuses are provided herein with respect to a WTRU that may transmit a Cell WUS indication to request to change an SSB muting pattern. A WTRU may receive configuration information. The configuration information may include a set of one or more of two SSB muting patterns. For example, an SSB muting pattern configuration may include, for one or more (e.g., each) pattern(s), the number of SSBs per burst, periodicity per burst, and/or which SSBs are transmitted in one or more (e.g., each) burst(s). For example, an SSB muting pattern configuration may include 8 SSBs per burst with periodicity 20 ms and/or another SSB muting pattern may include 4 SSBs per burst with periodicity 40 ms. The configuration information may include indication that a first SSB muting pattern from the set of SSB muting patterns is activated. The configuration information may include a RSRP threshold. The configuration information may include one or more delay threshold values.

The WTRU may perform one or more measurements on one or more non-muted SSBs based on the first (e.g., activated) SSB muting pattern, for example, when triggered by an RA event. The WTRU may select a non-muted SSB based on the one or more measurement(s), for example, non-muted SSB with the strongest (e.g., highest) RSRP. If the RSRP of the selected non-muted SSB is less than the RSRP threshold, the WTRU may determine a second SSB muting pattern based on one or more of the following: the number of SSBs per burst in one or more (e.g., each) SSB muting pattern(s); the periodicity associated with one or more (e.g., each) SSB muting pattern(s); which SSBs are transmitted in one or more (e.g., each) burst(s) in one or more (e.g., each) SSB muting pattern(s); and/or the time to the next burst of the activated SSB muting pattern (e.g., whether the time to the next burst is greater than a delay threshold). If the RSRP measurements of the non-muted SSBs are below a RSRP threshold, the WTRU may transmit a Cell WUS. Transmitting a Cell WUS may indicate the request to activate the second SSB muting pattern. If the RSRP measurements of the non-muted SSBs are below a RSRP threshold, the WTRU may receive a WUS response. Receiving a WUS response may indicate the activation of the second SSB muting pattern and/or another SSB muting pattern (e.g., ID of the activated SSB muting pattern). If the RSRP measurements of the non-muted SSBs are below a RSRP threshold, the WTRU may perform one or more measurements on one or more non-muted SSBs based on the second SSB muting pattern and/or other SSB muting pattern indicated by the WUS response. If the RSRP measurements of the non-muted SSBs are below a RSRP threshold, the WTRU may select a non-muted SSB (e.g., based on measurements). If the RSRP measurements of the non-muted SSBs are below a RSRP threshold, the WTRU may transmit a RACH preamble associated with the selected SSB.

Systems, methods, and apparatuses provided herein may include aspects common to one or more (e.g., all) embodiments. Common terminology and/or concepts may include one or more of the following.

Cell DTX active period may include a duration of time over which a configured cell DTX pattern is active (e.g., periods of time during On Duration periods of a Cell DTX pattern). The WTRU may be predefined/preconfigured to monitor PDCCH and/or other DL signals and/or channels during such time. This may be applicable (e.g., only) based on (e.g., after) a cell DTX configuration has been indicated by the NW to be activated.

Cell DTX inactive period may include a duration of time over which a configured cell DTX pattern is not active/inactive (e.g., periods of time outside periodic On Duration periods of a Cell DTX pattern). This may be applicable based on (e.g., only after) a cell DTX configuration has been indicated by the NW to be activated.

Cell DRX active period may include a duration of time over which a configured cell DRX pattern is active (e.g., period(s) of time during On Duration periods of a Cell DRX pattern. The WTRU may be predefined to (e.g., be allowed to) transmit UL signal(s) and/or on UL channel(s) during such time. This may be applicable based on (e.g., only after) a cell DRX configuration has been indicated by the NW to be activated.

Cell DRX inactive period may include a duration of time over which a configured cell DRX pattern is not active/inactive (e.g., periods of time outside periodic On Duration periods of a Cell DRX pattern). This may be applicable based on (e.g., only after) a cell DRX configuration has been indicated by the NW to be activated.

Activated Cell DRX/DTX may include a state of a configured cell DRX and/or Cell DTX pattern, where such state has been activated by L1/L2 DL signaling, RRC (re)-configuration, and/or cell common configurations, and/or has not been de-activated.

De-activated Cell DRX/DTX may include a state of a configured cell DRX and/or Cell DTX pattern, where such state has been deactivated by L1/L2 DL signaling, RRC (re)-configuration, and/or cell common configurations.

The terms Link between availability state and Cell DTX/DRX may be used interchangeably herein. The WTRU may determine a cell DTX state implicitly from a determined active availability state, and/or visa-versa. The WTRU may determine a cell DRX state implicitly from a determined active availability state, and/or visa-versa.

A Cell DTX configuration may refer to the Cell DTX active period as set of Cell DTX occasions. Such set may be parameterized by one or more of a duration between the start of successive occasions (e.g., Cell-DTX-cycle), an offset (e.g., Cell-DTX-offset) and/or a duration (e.g., Cell-DTX-duration) for one or more (e.g., each) Cell DTX occasion(s). For example, such parameters may be expressed in units of subframes (e.g., or milliseconds) in a similar (e.g., the same) way as the long WTRU DRX cycle. In such case, a Cell DTX occasion may include a time period that starts in a subframe satisfying [SFN×10+subframe number] modulo (Cell-DTX-cycle)=(Cell-DTX-offset), where SFN is a system frame number, and ends (Cell-DTX-duration) later. Additionally or alternatively, the Cell DTX configuration may include a slot offset with respect to the start of the subframe in which a Cell DTX occasion starts. One or more parameters of the Cell DTX configuration may be signaled by RRC, MAC CE and/or DCI (e.g., WTRU-specific or WTRU-group common).

The WTRU may be predefined and/or configured per Cell DTX and/or a Cell DRX configuration with one of the following parameters and/or behaviors. The WTRU may be predefined and/or configured per Cell DTX and/or a Cell DRX configuration with one or more applicable configured grant(s) and/or SPS configuration(s). For example, the WTRU may activate such configured grants upon activation of the cell DTX and/or cell DRX configuration. The WTRU may be configured per configured grant with whether the configured grant has priority over the configured cell DTX and/or cell DRX pattern (e.g., whether the WTRU can transmit and/or receive on a UL and/or DL CG during a cell DRX and/or cell DTX inactive period, respectively). The WTRU may be predefined and/or configured per Cell DTX and/or a Cell DRX configuration with whether the WTRU may monitor PDCCH for dynamic grants and/or dynamic DL assignments during the cell DTX inactive period. The WTRU may be predefined and/or configured per Cell DTX and/or a Cell DRX configuration with whether to transmit on dynamic grants and/or configured grants. The WTRU may be predefined and/or configured per Cell DTX and/or a Cell DRX configuration with PRACH resources and/or PRACH resource configuration that may be applicable during a Cell DRX inactive period and/or if a cell DRX configuration is activated. The WTRU may be predefined and/or configured per Cell DTX and/or a Cell DRX configuration with SR/PUCCH resources and/or SR/PUCCH resource configuration that may be applicable during a Cell DRX inactive period and/or if a cell DRX configuration is activated. The WTRU may be predefined and/or configured per Cell DTX and/or a Cell DRX configuration with CSI-reporting and/or CSI-reporting resource configurations that may be applicable during a Cell DRX inactive period and/or if a cell DRX configuration is activated. The WTRU may be predefined and/or configured per Cell DTX and/or a Cell DRX configuration with SRS resources and/or SRS resource configuration that may be applicable during a Cell DRX inactive period and/or if a cell DRX configuration is activated.

The WTRU may be configured with one or more (e.g., multiple) cell DRX and/or cell DTX configurations simultaneously in a given serving cell. The WTRU may be configured with a primary and/or a default cell DTX and/or cell DRX configuration, which the WTRU may apply by default. Upon reception of signaling activating one cell DTX and/or cell DRX configuration, for example, the WTRU may deactivate another cell DTX (e.g., or all other cell DTXs). Upon reception of signaling deactivating one cell DTX and/or cell DRX configuration, the WTRU may activate another cell DTX and/or activate a default cell DTX/DRX configuration. Upon expiry of a timer, the WTRU may fallback to the default cell DRX and/or cell DTX configuration. The WTRU may reset such timer upon reception of DL signaling and/or data and/or an indication from the NW to remain in a given non-default cell DTX and/or cell DRX state.

Systems, methods, and apparatuses may be provided herein with respect to Cell WUS configuration. The UE may be configured to transmit a request to the network (e.g., wake-up request and/or wake-up signal/indication) to modify the availability state to a state for which the resources that would satisfy one or more WTRU requirements are available. The wake-up signal/indication may be referred to as Cell wake-up signal (WUS) or UL indication.

The WTRU may be predefined and/or configured on the basis of per availability/NES state, per Cell DTX, Cell DRX, and/or per SSB/beam configuration with one or more of the following parameters and/or behaviors associated with Cell WUS indication. The WTRU may be predefined and/or configured with one or more sequences/time/frequency resources associated with the transmission of a Cell WUS indication. The WTRU may be predefined and/or configured with the resources associated with Cell WUS that may correspond to any of the following: PRACH resources and/or PRACH resource configuration, SR/PUCCH resources and/or SR PUCCH resource configuration and/or a new set of sequences/time/frequency resources. The WTRU may be predefined and/or configured with such resources for Cell WUS that may be applicable during a WUS occasion (e.g., resource and/or configuration during which the WTRU may transmit a Cell WUS indication and/or the base station may monitor for an UL transmission). The WTRU may be predefined and/or configured with such resources for Cell WUS that may be applicable during a Cell DTX active/inactive and/or Cell DRX inactive period.

Systems, methods, and apparatuses provided herein may be with respect to transmission pattern of NES SSBs. In examples, the WTRU may be configured with one or more transmission patterns associated with NES SSBs. The one or more different transmission pattern(s) may be associated with the different availability/NES states of the cell. The transmission pattern of NES SSBs may include one or more NES SSBs and/or beams in a burst that may be transmitted by the cell with certain periodicity in an availability/NES state. Such NES SSBs may be used by the WTRU for similar purposes associated with non-NES SSBs or legacy SSBs, such as for DL synchronization, accessing MIB/SIBs and beam selection. The NES SSBs in a transmission pattern may include a combination of one or more of the following. The NES SSBs in a transmission pattern may include a combination of PSS and SS. The SSBs and/or beams may include PSS and SSS signals (e.g., 2 symbols), without any PBCH (MIB). Such signals may be used by the WTRU for DL synchronization, prior to transmitting an UL indication to request for PBCH/RMSI, for example. Such signals may be referred to as discovery reference signals (DRS). The NES SSBs in a transmission pattern may include a combination of PSS, SSS, and partial PBCH. In addition to the PSS and SSS signals, the SSBs and/or beams may include (e.g., some) MIB information, including one or more of the following: SFN, subcarrier spacing, SSB subcarrier offset, DMRS, and/or cell barring. Such signals may include any indication to a PDCCH/PDSCH from which the SIB1 may be determined by the WTRU. Such signals may be referred to as light SSBs. The NES SSBs in a transmission pattern may include a combination of CSI-RS, TRS and/or PT-RS. The SSBs and/or beams may include any of CSI-RS, TRS and/or PT-RS signals and/or may be used by the WTRU for DL synchronization and/or beam/phase tracking. The NES SSBs in a transmission pattern may include a combination of PRS. The PRS signals and/or beams may be used by the WTRU for detecting the cells/beams and/or for performing measurements associated with positioning, including one or more of timing, angle and/or received power-based measurements (e.g., reference signal time difference (RSTD)RTSD, RSRP).

The transmission pattern associated with NES SSBs may include one or more of the time domain locations/positions (e.g., within a frame or half frame) of the NES SSBs within a burst. Such locations may be indicated to the WTRU via one or more bitmaps of different lengths (e.g., short, long), where a “1” in a bitmap may indicate the presence of an SSB beam in a burst and “0” may indicate an absence of an SSB beam. One or more other parameters associated with the transmission pattern of NES SSBs that may be configured in the WTRU may include SSB type (e.g., periodic, aperiodic, semi-persistent), periodicity of the NES SSBs, start slot/offset, duration, subcarrier spacing, subcarrier offset, and/or SS block power, for example. An NES SSB occasion, during which one or more SSBs may be transmitted, may include a time period that starts in a subframe satisfying [SFN×10+subframe number] modulo (NES-SSB-cycle)=(NES-SSB-offset), where SFN is a system frame number, and ends (NES-SSB-duration) later. Additionally or alternatively, the NES SSB transmission pattern may include a slot offset with respect to the start of the subframe in which a NES SSB occasion starts. One or more parameter(s) of the configuration of the NES SSB transmission pattern may be signaled by RRC, MAC CE and/or DCI (e.g., via WTRU-specific and/or WTRU-group common signaling). In examples, the NES SSB transmission pattern may correspond to an SSB muting pattern, wherein an SSB muting pattern may include of one or more SSBs and/or beams in a burst that may be muted and/or not transmitted.

The WTRU may be configured with one or more (e.g., multiple) NES SSB transmission patterns and/or configurations simultaneously in a given serving cell. The WTRU may be configured with a primary and/or a default NES SSB transmission pattern, which the WTRU may apply by default. Upon reception of signaling indicating activation of one NES SSB transmission pattern, for example, the WTRU may deactivate another one (e.g., or all other ones). Upon reception of signaling indicating deactivation of one NES SSB transmission pattern, the WTRU may activate another NES SSB transmission pattern and/or activate a default NES SSB transmission pattern. Upon expiry of a timer, the WTRU may fallback to the default NES SSB transmission pattern. The WTRU may reset such timer upon reception of DL signaling and/or data and/or an indication from the NW to use a given non-default NES SSB transmission pattern.

When receiving a cell activity indication (e.g., when the base station transitions to cell DTX/DRX mode), the WTRU may apply one or more NES SSB transmission pattern(s) for synchronizing with the network (e.g., via PSS & SSS) and/or for accessing SSBs/SIBs based on the indicated/identified availability of the cell. The WTRU may identify the NES SSB transmission pattern(s) to apply based on a configured association info between the transmission patterns and the availability state and/or based on the one or more transmission pattern identifiers/indexes received in the configuration information and/or activity indication.

Whether the WTRU may prioritize a configured NES SSB transmission pattern and/or any of the WTRU-specific channel/signals may be predefined, configured, and/or determined as a function of any one or more of the following: the WTRU capability, data priority and/or latency, and/or the control signaling/info type. One example of a WTRU signal and/or channel that may have priority to override a configured NES SSB transmission pattern is a CG transmission, SR transmission, and/or transmission of a cell WUS indication.

When operating in cell DTX mode, a base station may transmit DTX SSBs according to a DTX transmission pattern. For example, a transmission pattern for DTX SSBs may include a set of DTX SSBs which may be a smaller set compared to a set of non-DTX SSBs. The set of DTX SSBs may be transmitted less frequently (e.g., lower periodicity) compared to non-DTX SSBs. The set of DTX SSBs may include PSS and/or SSS, and/or may not include PBCH. The terms “DTX SSBs” and “NES SSBs” may be used interchangeably and/or may refer to one or more (e.g., any) SSBs and/or beams transmitted by a cell when operating in an NES state (e.g., cell DTX mode).

Systems, methods, and apparatuses may include a WTRU that receives configuration information and/or parameters associated with NES/DTX SSBs and/or Cell WUS. In examples, the WTRU may receive configuration information and/or parameters associated with Cell WUS and/or NES/DTX SSBs. The configuration information and/or parameters received by the WTRU may be applicable for one or more embodiments, as described herein. The configuration information may be received in broadcast transmission (e.g., MIB, SIB) and/or in dedicated RRC signaling (e.g., in RRCReconfiguration message) during CONNECTED mode or in INACTIVE/IDLE mode (e.g., RRCRelease message, when transitioning from CONNECTED mode). Additionally or alternatively, the configuration information and/or any of the associated parameters (e.g., IDs/indexes), including a subset of the parameters and/or any update to the configuration, may be received by the WTRU in one or more cell activity indications, for example. Such cell activity indication may be received in RRC signaling, MAC CE, PDCCH or PDSCH, for example. Such cell activity indication may be received by the WTRU via a reference beam (e.g., last SSB beam associated with the WTRU before cell DTX/DRX), for example.

The configuration information received by the WTRU may include one or more of the following.

The configuration information received by the WTRU may include DTX SSB transmission pattern. For example, the transmission pattern of DTX SSBs may include one or more of the following: periodicity, start offset, duration, positions of DTX SSBs in a burst and/or index(es) associated with the DTX SSBs. The DTX SSBs received by the WTRU during cell DTX mode may include wider beams, fewer number of beams per SSB burst and/or lower periodicity compared to non-DTX SSBs received by the WTRU during a non-cell DTX mode, for example.

The configuration information received by the WTRU may include SSB muting pattern. For example, the parameters associated with a SSB muting pattern configuration may include one or more of the following: SSB muting pattern ID/index, periodicity, start slot/offset, burst duration, positions of active/muted SSBs in a burst (e.g., bitmap indication active/muted SSBs) and/or index(es) associated with the active/muted SSBs. The WTRU may be preconfigured with one or more (e.g., multiple) SSB muting patterns. One or more SSB muting patterns may be activated/deactivated via the cell activity indication, DCI, MAC CE and/or RRC signaling. An SSB muting pattern may include 8 non-muted SSBs per burst with periodicity 20 ms or 4 non-muted SSBs per burst with periodicity 40 ms. An SSB muting pattern may indicate which SSBs (e.g., which SSB indexes) are muted and/or not muted in one or more (e.g., each) burst(s), where the SSBs available (e.g., not muted) in consecutive bursts may be the same or different. The SSB muting pattern may be a pattern from a set of configured patterns and/or may be indicated by a pattern ID and/or index. In examples, the WTRU may be implicitly configured with a SSB muting pattern when configuring the cell DTX pattern. In examples, the WTRU may determine one or more (e.g., some) parameters associated with the SSB muting pattern, such as periodicity and/or duration of non-muted SSBs in a burst, based on association/alignment of the SSB muting pattern with the cell DTX pattern.

The configuration information received by the WTRU may include Cell WUS resources. For example, the Cell WUS resources may be received by the WTRU as group-common resources (e.g., RACH preambles/sequences) and/or dedicated WTRU-specific resources (e.g., PUCCH resource). Such resources may be indicated as a mapping relation between one or more DTX SSBs/non-muted SSBs/beams and one or more Cell WUS resources.

The configuration information received by the WTRU may include Cell WUS response time duration. Cell WUS response time duration may refer to the duration of (e.g., in symbols/slots/subframes) that may be started by the WTRU in nth time instance (e.g. slot n=1) based on (e.g., after) transmitting Cell WUS indication and/or stopped at the end of the duration (e.g., slot n+N, wherein the timer duration corresponds to N slots). During the Cell WUS response duration, the WTRU may monitor for any of DL the signals/beams including any of PDCCH, PDSCH, SIBs and/or SSBs (e.g. non-DTX SSBs).

The configuration information received by the WTRU may include UL resources associated with a reference SSB beam. For example, a reference SSB beam may correspond to the last SSB beam (e.g., beam index) associated with the WTRU based on (e.g., before) receiving a cell activity indication (e.g., when cell transitions to cell DTX mode). The UL resources may correspond to any of PUCCH/SR resources (e.g., may be used by the WTRU for transmitting SR during cell DTX mode when triggered by an SR event), RACH preambles and/or Cell WUS resources.

The configuration information received by the WTRU may include validity time durations. For example, the one or more validity time durations may include any of TA validity duration and/or a beam validity duration. Such validity durations may be used by the WTRU for determining whether certain WTRU action(s) may be performed (e.g., monitor PDCCH and/or transmit SR) when the associated timers (e.g., TAT) are triggered and/or running/valid. The beam validity timer may be used for determining whether any configurations and/or resources associated with a reference SSB and/or configured SSB beam is valid for usage during DL/UL transmissions of signaling/data, for example. The beam validity timer may be associated with a single reference SSB beam and/or a set of SSB beams (e.g., in a burst). At the expiry of the beam validity timer, for example, the WTRU may determine (e.g., assume) the beam is no longer valid and/or may release any configurations (e.g., TCI state) and/or resources (e.g., SR, CSI-RS) associated with the reference beam(s).

The configuration information received by the WTRU may include Cell WUS prohibit timer duration. The prohibit timer may be started, for example, by the WTRU upon transmitting a cell WUS indication. For example, the WTRU may not transmit a subsequent cell WUS indication while the prohibit timer is running. The WTRU may transmit a cell WUS indication based on (e.g., after) the expiry of the prohibit timer.

The configuration information received by the WTRU may include RSRP/RSRQ threshold value(s). For example, the WTRU may be configured with one or more RSRP/RSRQ threshold values for determining whether a non-muted/DTX SSB may be selected and/or for determining whether transmission of new/muted SSB(s) or beam(s) may be triggered.

Systems, methods, and apparatuses may be provided herein with respect to a WTRU synchronizing with NES/DTX SSBs based on (e.g., before) transmitting SR. In examples, the WTRU may determine whether/when to transmit an UL indication to trigger SSB transmission from a cell operating in an NES state based on DL synchronization achieved with signals/beams received during the corresponding NES state. Such embodiments may be applied by the WTRU when detecting any of the triggering events/conditions associated with transmission of the UL indication (e.g., as described herein). Such embodiment(s) may be applied during any one or more of the following: when the base station operates in a cell DTX mode, based on (e.g., after) the WTRU receives a cell activity indication and/or upon detecting/receiving one or more DTX SSBs during the occasions associated with cell DTX.

The WTRU may start one or more validity timer(s). In examples, the WTRU may start a beam validity timer upon receiving the configuration information associated with cell DTX and/or the cell activity indication. The beam validity timer may correspond to any timer associated with one or more configurations, resources, SSBs and/or beams. In examples, the beam validity timer may correspond to the TA timer. The cell activity indication may indicate the initialization of cell operation in an NES state such as cell DTX/DRX. The WTRU may receive DTX SSBs during the NES state (e.g., cell DTX) and/or the WTRU may perform one or more actions corresponding to the NES state (e.g., as described herein). For example, when triggered by an event in the associated NES state, the WTRU may perform one or more actions depending on the validity of the validity timer (e.g., whether the beam validity timer is running or stopped).

The WTRU may monitor for DTX SSBs based on detection of triggering events and/or conditions. In examples, the WTRU may initiate monitoring of DTX SSBs during cell NES state operation (e.g., cell is in DTX/DRX mode) when detecting one or more triggering events/conditions. Such triggering events/conditions, for initiating DTX SSB monitoring prior to transmission of an UL indication (e.g., Cell WUS), may include one or more of the following: Random Access Events, UL data transmission, and/or CSI-RS measurements/reporting.

Triggering events/conditions, for initiating DTX SSB monitoring prior to transmission of an UL indication (e.g., Cell WUS), may include Random Access Events. For example, the WTRU may start monitoring of DTX SSBs during any one or more of the following: prior to transmitting any of initial access messages (e.g., RACH preamble, Msg1, Msg3, MsgA), when triggered by events associated with establishing connection with the network, when resuming a suspended connection (e.g., when transitioning from INACTIVE to CONNECTED state), when requesting for on-demand SI, and/or when initiating handover (HO) from a source cell to a target cell.

Triggering events/conditions, for initiating DTX SSB monitoring prior to transmission of an UL indication (e.g., Cell WUS), may include UL data transmission. For example, such triggering events may include one or more of the following: triggering of SR due to arrival of UL data in WTRU buffers (e.g., DRB/LCH buffers), priority of the UL data (e.g., arrival of URLLC and/or XR data with a priority value above a threshold) and/or delay associated with UL data (e.g., time-to-live or remaining delay of data is below a delay threshold).

Triggering events/conditions, for initiating DTX SSB monitoring prior to transmission of an UL indication (e.g., Cell WUS), may include CSI-RS measurements/reporting. For example, such triggering events may include detection of measurement events associated with periodic, and/or semi-persistent CSI-RS by and/or when the WTRU has one or more CSI reports for transmission.

When monitoring for the DTX SSBs, the WTRU may perform measurements on the detected beams. The WTRU may determine the DTX SSBs and/or beams to be measured based on a measurement configuration (e.g., comprising of a DTX SSB transmission pattern, measurement duration, RSRP threshold values) received by the WTRU, for example. The WTRU may select one or more of the DTX SSBs and/or beams based on measurements (e.g., L1-RSRP). For example, the WTRU may select a DTX SSB and/or beam, wherein the RSRP of the DTX SSB and/or beam measured by the WTRU is greater than an RSRP threshold value and/or the RSRP of the DTX SSB and/or beam is the highest measured RSRP among the detected set of DTX SSBs.

The WTRU may transmit an UL indication (e.g., Cell WUS). In examples, the WTRU may transmit an UL indication to the network using a resource associated with the selected DTX SSB and/or beam when triggered by certain events/conditions. Such UL indication may include one or more of the following configurations and/or resources: Cell WUS indication, SR and/or RACH preambles, for example. Such UL indication may be transmitted periodically when configured with periodic resources. Such UL indication may be used for requesting the network and/or for providing preference information to the network on any one or more of the following: initiate transmission of non-DTX SSBs, request to transition to a new and/or non-NES state, request for UL grant for SR/BSR/data transmission, indication of preference for certain SSBs and/or beams, indication of preference for an SSB burst periodicity, request for CSI-RS transmission via certain beams, and/or request for any RMSI/SIBs. Such UL indication may be transmitted using the spatial filter associated with the reference SSB, and/or the selected DTX SSB and/or beam, for example. The WTRU may start a prohibit timer upon transmitting an UL indication (e.g., Cell WUS). Upon starting the prohibit timer, the WTRU may not transmit any subsequent UL indications until the expiry of the prohibit timer and/or upon reception of a response indication.

The WTRU may transmit the UL indication during a WUS occasion (WO), during which the base station/cell may monitor for any UL transmission from the WTRU, for example. A WO may correspond to an uplink resource and/or configuration (e.g., RACH, SR, PUSCH, PUCCH) that may be used by the WTRU for transmitting a Cell WUS indication and/or an UL transmission (e.g., PUSCH data or signaling/control message), for example, following a cell DRX interruption. In the case when a WUS occasion pattern is configured (e.g., comprising of oof periodicity of WOs, WO duration, start slot/offset), for example, the WTRU may transmit any UL indication during the next available WUS occasion, possibly associated with the selected DTX SSB. If a WUS occasion pattern is not configured, for example, the WTRU may determine (e.g., assume) the availability of a WUS occasion n symbols/slots (e.g. n=1) based on (e.g., after) the reception of the last DTX SSB in an DTX SSB burst, for example.

The triggering events/conditions used by the WTRU for determining whether to transmit the UL indication may be similar with those associated with initiating the monitoring of DTX SSBs during cell NES state operation. In examples, if any of the triggering conditions (e.g., detection of RA events, SR events, CSI-RS reporting events) are pending and/or not cancelled, the WTRU may transmit an UL indication (e.g., Cell WUS) upon selecting a DTX SSB, for example. The one or more other conditions which may be monitored by the WTRU for determining whether the UL indication may be transmitted may include the validity timer associated with beam validity timer and/or TAT. For example, the WTRU may transmit an UL indication if and/or when (e.g., only if and/or when) the TAT is not expired. In examples, the WTRU may transmit the SR if the TAT timer is not expired and/or if one or more SR is triggered/pending, for example. Similarly, the WTRU may transmit an UL indication (e.g., Cell WUS) if and/or when the beam validity timer (e.g., or the TAT) is expired. In examples, the WTRU may transmit a Cell WUS using a cell WUS resource, (e.g., instead of an SR) if the beam validity timer (e.g., or TAT) has expired and/or if one or more SR is triggered/pending, for example.

In examples, if the TAT has expired, the WTRU may transmit a RACH preamble to the cell associated with the selected DTX SSB. In examples, the WTRU may not transmit the Cell WUS.

In examples, if the beam validity timer (e.g., or the TAT) has not expired, and one or more SR is pending and/or an SR event occurs (e.g., new UL data arrives), the WTRU may transmit SR using one or more configured SR/PUCCH resource(s). The WTRU may receive a PUSCH resource in DCI and/or (e.g., subsequently) the WTRU may transmit BSR using the PUSCH resource.

In examples, the WTRU may provide the base station/cell with assistance information regarding which DTX SSBs/beams be kept on/active. Such information may be provided in UL/Cell WUS indication, for example. Such information may be provided in CSI-RS reports, for example. For example, the WTRU may utilize periodic and/or trigger aperiodic CSI reports for transmitting the associated assistance information to the base station/cell by indicating which set and/or subset of beams the base station/cell should keep on/active and/or which may be turned off and/or muted from a WTRU coverage perspective.

In examples, the WTRU may indicate a desire (e.g., need) for changing the cell state (e.g., from DTX to active) and/or a change of beam assignment if certain reference signal (e.g., CSI-RS) measurements (e.g., RSRP, RSRQ) fall below a certain threshold value.

In examples, the WTRU may utilize positioning-based measurements (e.g., measurements of DL PRS), to request a change in the cell's NES state/beam assignment. For example, if the RSRP of DL PRS per beam falls below a certain threshold when cell is in a reduced availability/energy state, the WTRU may trigger a request to change the NES state and/or beam, (e.g., possibly in the Cell WUS indication). In examples, the WTRU may trigger and/or transmit a request for a wake up and/or update the beam assignment if the DL RSTD of PRS between other cells and the current serving (e.g., reference) cell exceeds an RSTD threshold value.

In examples, the WTRU may maintain a list of best ‘k’ beams based on most recent beam sweep/measurements. The WTRU may update the list of best ‘k’ beams based on a cell activity indication received from the base station on the set of beams deactivated when transitioning to an NES/DTX state. The WTRU may exclude these beams and/or may choose from the strongest (e.g., best) in remaining ‘k’, upon receiving the cell activity indication. If the remaining number of available beams is below a threshold and/or the measured RSRP of the reduced beam set is below a threshold, the WTRU may transmit a Cell WUS indication to the base station on the updated list of beams. The WTRU may (e.g., then) receive a WUS response indication from the base station on an alternate or reduced set of beams.

The WTRU may receive a WUS response indication from the network upon transmitting the UL indication (e.g., Cell WUS indication). The WTRU may start a WUS response timer m symbols/slots (e.g., m=1) based on (e.g., after) transmitting the UL indication during a WUS occasion. The WTRU may monitor for a WUS response indication while the WUS response timer is running, for example. The WTRU may stop and reset the prohibit timer associated with the Cell WUS, upon receiving a WUS response, for example.

The WUS response may be received by the WTRU in PDCCH, MAC CE and/or RRC signaling, for example. The WUS response may be received in a WTRU specific signaling and/or group-common signaling. When receiving the WUS response in PDCCH, the CRC of the PDCCH may be scrambled with a WUS-RNTI, for example. The WUS response may be received via the beam used by the WTRU for transmitting the UL indication and/or Cell WUS, for example. In examples, the WTRU may receive an implicit WUS response, where the reception of an implicit WUS response may be determined (e.g., assumed) by the WTRU when detecting one or more new SSBs (e.g., new SSBs may include one or more of the following: non-DTX SSBs, SSBs different from or in addition to the DTX SSBs, other SSBs that may have been activated and may now be available).

The explicit WUS response indication may include one or more of the following: indication of new SSBs (e.g., index(es) associated with one or more non-DTX SSBs) to be transmitted in DTX mode and/or based on (e.g., after) the cell transitions to a non-DTX mode, indication of a new availability/NES state/mode to which the cell may be transitioning to (e.g., state ID/index), indication of TCI state change (e.g., when a new/preferred beam is indicated in Cell WUS indication) and/or one or more PUCCH resources (e.g., for transmitting SR, CSI-RS report and/or HARQ feedback).

Systems, methods, and apparatuses provided herein may include one or more WTRU actions upon/when receiving/not receiving a WUS response indication. If the WUS response is received by the WTRU based on (e.g., before) the expiry of the WUS response timer, the WTRU may transmit SR using the PUCCH resource indicated in the WUS response. The WTRU may transmit SR, upon receiving the WUS response, for example, when the WTRU may have previously transmitted a Cell WUS indication and/or when one or more SR is pending. The WTRU may transmit SR using a new SSB (e.g., non-DTX SSB beam), which may be associated with the DTX SSB beam used for transmitting the Cell WUS indication, for example.

Additionally or alternatively, in examples, if an explicit WUS response is not received by the WTRU based on (e.g., before) the expiry of the WUS response timer, the WTRU may monitor for an implicit WUS response in the form of initiation of new SSBs (e.g., SSBs different from or in addition to the DTX SSBs, other SSBs that may have been activated and/or may now be available). Such monitoring for new SSBs may be done by the WTRU, for certain time duration, based on (e.g., before and/or after) the expiry of the WUS response timer. The WTRU may select a new SSB (e.g., SSB beam) based on one or more measurements (e.g., L1 RSRP) and/or using a criteria associated with the one or more measurements (e.g., RSRP measurements of the new SSB is above a threshold value and/or highest among the detected new SSBs). The WTRU may transmit a RACH preamble associated with the selected new SSB beam and/or may receive the RACH response (RAR) including the PUCCH resource for SR. The WTRU may (e.g., then) transmit SR using the received PUCCH resource via an UL beam that is in correspondence with the selected new SSB beam.

In examples, if an explicit WUS response is not received by the WTRU based on (e.g., before) the expiry of the WUS response timer, the WTRU may retransmit the Cell WUS indication (e.g., possibly after the expiry of the associated prohibit timer). The WTRU may retransmit the Cell WUS indication for N configured instances/attempts based on (e.g., before) termination and/or releasing any configuration information associated with Cell WUS.

In examples, if the TAT has expired, the WTRU may transmit a RACH preamble to the cell associated with the selected DTX SSB. In examples, the WTRU may not transmit the Cell WUS.

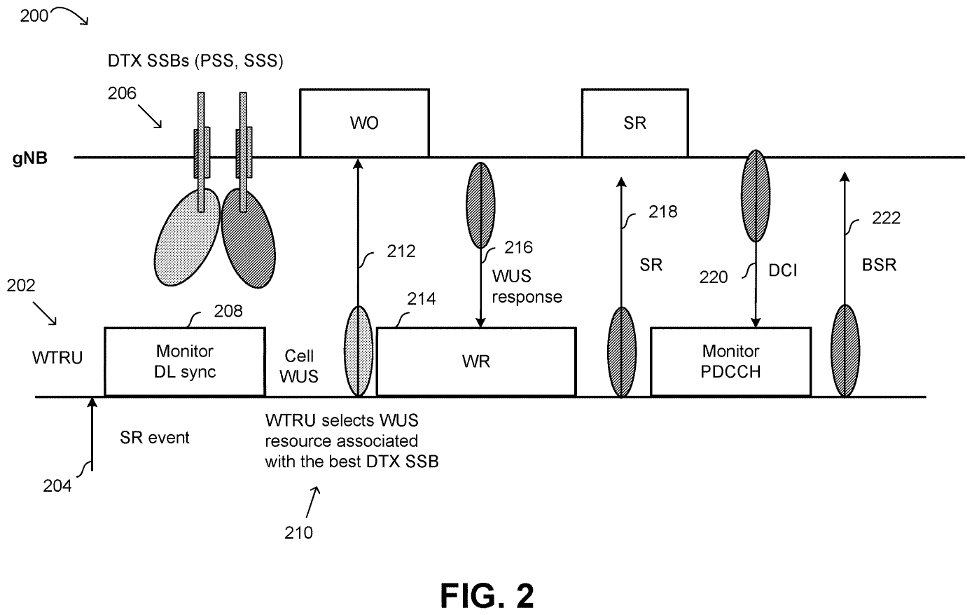

FIG. 2 depicts a system diagram illustrating an example of a WTRU 202 that may be configured to achieve DL synchronization with DRX SSBs based on a DTX SSB transmission pattern 200. When triggered by an SR event 204 (e.g., UL data arrival), the WTRU 202 may determine to transmit a Cell WUS 212 (e.g., a cell WUS indication), using resources associated with one of a plurality of DTX SSBs 206, for initiating transmission of new SSBs (e.g., non-DTX SSBs) from the cell. The WTRU 202 may receive information of the new SSBs in a WUS response 216. The WTRU 202 may select a new SSB for transmitting the SR 218 (e.g., possibly upon transmitting initial access messages via the selected new SSB).

In examples, the WTRU 202 may perform one or more of the following.

A WTRU 202 may receive configuration information (e.g., when the cell transitions to cell DTX mode). The configuration information may include one or more Cell WUS resources (e.g., mapping between DTX SSBs 206 and Cell WUS resources). For example, the set (e.g., plurality) of DTX SSBs 206 compared with the set of non-DTX SSBs may be a smaller set, may be transmitted less often, may include PSS and/or SSS, and/or may not include PBCH. The configuration information may include one or more SR resource(s) associated with a reference SSB beam (e.g., last beam associated with the WTRU 202 before cell DTX). The configuration information may include a TA time duration. The configuration information may include a WUS response duration. The configuration information may include a beam validity time duration.

Additionally or alternatively, the WTRU 202 may start a TA timer. Additionally or alternatively, the WTRU 202 may start a beam validity timer.

At 208, the WTRU 202 may initiate monitoring of the DTX SSBs 206 (e.g., wide beams). For example, the WTRU 202 may monitor DL sync when triggered by an SR event 204. The SR event 204 may include data the WTRU 202 has to transmit.

At 210, the WTRU 202 may select a DTX SSB, for example, based on measurements. For example, the WTRU may select a WUS resource associated with the best DTX SSB.

At 212, the WTRU 202 may select a resource associated with the best (e.g., selected) DTX SSB of the plurality of DTX SSBs 206. The WTRU may transmit the Cell WUS 212 using the resource associated with the selected DTX SSB. For example, the WTRU 202 may transmit the Cell WUS 212 if and/or when (e.g., only if and/or when) the TAT is not expired. For example, the WTRU 202 may transmit the Cell WUS 212 if and/or when the beam validity timer (e.g., or the TAT) is expired.

At 214, the WTRU 202 may start a WUS response timer and/or may monitor for a WUS response 216. For example, the WUS response 216 may include one or more of: a PUCCH resource, and/or index(es) for one or more new SSBs (e.g., new SSBs may include one or more of the following: non-DTX SSBs, SSBs different from and/or in addition to the DTX SSBs, one or more other SSBs that may have been activated and/or may now be available).

If the WUS response 216 is received based on (e.g., before) the expiry of the response timer, the WTRU 202 may monitor for new SSBs (e.g., SSB beams). If the WUS response 216 is received based on (e.g., before) the expiry of the response timer, the WTRU 202 may select a new SSB (e.g., based on one or more measurements). If the WUS response 216 is received based on (e.g., before) the expiry of the response timer, the WTRU 202 may transmit a RACH preamble associated with a selected new SSB. If the WUS response 216 is received based on (e.g., before) the expiry of the response timer, the WTRU 202 may receive (e.g., in RAR), the configuration information (e.g., PUCCH resource for SR) of the selected new SSB. If the WUS response 216 is received based on (e.g., before) the expiry of the response timer, the WTRU 202 may transmit a SR 218 via the selected new SSB.

If the WUS response 216 is not received and/or the response timer expires, the WTRU 202 may retransmit the Cell WUS indication(s) 212 (e.g., for N attempts before termination).

If the TAT has expired, the WTRU 202 may transmit a RACH preamble to the cell associated with the selected DTX SSB. The WTRU 202 may not send the Cell WUS, when the TAT has expired.

If the beam validity timer (e.g., or the TAT) has not expired and/or the SR 218 is pending and/or an SR event occurs, for example, the WTRU 202 may transmit the SR 218 using the configured resource. If the beam validity timer (e.g., or the TAT) has not expired and/or an SR is pending and/or an SR event occurs, for example, the WTRU may receive PUSCH resource for a BSR 222 in DCI 220. If the beam validity timer (e.g., or the TAT) has not expired and/or the SR 218 is pending and/or an SR event occurs, for example, the WTRU 202 may transmit the BSR 222 using the PUSCH resource.

Systems, methods, and apparatuses may be provided herein with respect to a WTRU that transmits a Cell WUS indication to wake up muted SSBs when configured with an SSB muting pattern.

In examples, the WTRU may determine whether to transmit a Cell WUS indication when a limited and/or reduced number of SSBs are received according to a SSB muting pattern, based on DL synchronization achieved with the non-muted SSBs. Such embodiment(s) may be applied by the WTRU when detecting any one or more of the triggering events/conditions associated with transmission of the UL and/or Cell WUS indication (e.g., as described herein). Such embodiment(s) may be applied when an SSB muting pattern is applied by a cell operating in an NES state (e.g., cell DTX/DRX), wherein one or more (e.g., only a subset of) SSBs are transmitted.

In examples, the WTRU may initiate monitoring of non-muted SSBs based on the configured SSB muting pattern when detecting one or more triggering events/conditions (e.g., detection of a RA event and/or an SR event). The WTRU may perform one or more measurements on the detected SSB beams identified during monitoring of the non-muted SSBs. The WTRU may determine the non-muted SSBs to perform one or more measurements based the configured SSB muting pattern. For example, the WTRU may perform one or more measurements in the slots/occasions during which the non-muted SSBs may be received and/or may skip the slots/occasions associated with the muted SSBs.

If RSRP of any one or more of the non-muted SSBs is above an RRSP threshold value, the WTRU may select a non-muted SSB based on the measurements and/or may transmit a RACH preamble associated with the selected non-muted SSB for initial access and/or establishing connection with the network. Additionally or alternatively, if the RSRP of any of the non-muted SSBs is below a configured RSRP threshold value, the WTRU may select a first SSB from among the non-muted SSBs based on the RSRP measurements (e.g., the WTRU may select a non-muted SSB with the highest measured RSRP as the first SSB).

The WTRU may select one or more of the DTX SSBs based on measurements (e.g., L1-RSRP). For example, the WTRU may select a DTX SSB (e.g., SSB beam), if the RSRP of the DTX SSB beam measured by the WTRU is greater than an RSRP threshold value and/or the RSRP of the DTX SSB beam has the highest measured RSRP among the detected set of DTX SSBs.

In examples, the WTRU may transmit a Cell WUS indication. For example, when receiving configuration information from the network, the WTRU may (e.g., optionally) receive an indication and/or configuration information indicating that SSB muting is enabled. The SSB muting pattern ID may be received when the SSB muting is enabled (e.g., in the same message associated with the configuration information, cell activity indication, DCI and/or MAC-CE).

In examples, the WTRU may transmit the Cell WUS indication to the network using a resource associated with the first SSB (e.g., selected non-muted SSB) when triggered by certain events/conditions. Such Cell WUS indication may be transmitted using resources and/or the spatial filter associated with the first SSB, for example.

Such Cell WUS indication may be used for requesting the network and/or for providing preference information to the network on any one or more of the following: initiate transmission of muted one or more SSBs (e.g., SSBs adjacent to the selected non-muted/first SSB), request to change/suspend/disable the SSB muting pattern, and/or request to transition to a non-NES state. Such Cell WUS indication may be transmitted during a WUS occasion associated with the first SSB configured in the WTRU, for example. For example, the WTRU may be configured with one or more WUS occasions associated with the muted/non-muted SSBs during which the WTRU may transmit the UL indication. If a WUS occasion pattern is not configured, the WTRU may determine (e.g., assume) the availability of a WUS occasion n symbols/slots (e.g. n=1) based on (e.g., after) the reception of the last muted/non-muted SSB in an SSB burst, for example.

In examples, the WTRU may receive a WUS response indication from the network upon transmitting the Cell WUS indication. The WUS response may be received via one or more resources associated with the first SSB (e.g., via the SSB/beam used by the WTRU for transmitting the cell WUS indication).

The WUS response indication may include one or more of the following: indication of new SSBs that may have been activated and/or may now be available (e.g. index(es) associated with one or more new SSBs, wherein the new SSBs may be the previously muted SSBs associated with the SSB muting pattern and/or new SSBs outside of the SSB muting pattern), indication of disabling of the SSB muting and/or the SSB muting pattern, indication of a new SSB muting pattern (e.g., pattern ID/index), indication of a new availability/NES state to which the cell may be transitioning to, one or more PUSCH resources (e.g., UL grant for transmitting RRC signaling/messages and/or data) and/or PUCCH resources (e.g., for transmitting SR, CSI-RS report or HARQ feedback).

The WTRU may perform one or more actions based on (e.g., after) receiving a WUS response indication. In examples, the WTRU may monitor for a set of one or more SSBs based on the information received in the WUS response indication. The set of SSBs monitored by the WTRU may include one or more of the following: the newly activated/available SSBs, SSBs associated with the new muting pattern and/or unmuted SSBs in previous SSB muting pattern, for example.

The WTRU may select a second SSB (e.g., new SSB beam) from the monitored set of SSBs based on one or more measurements (e.g., L1 RSRP) and/or using a criteria associated with the measurements (e.g., RSRP measurements of the second SSB is above a threshold and/or highest among the detected SSB). The WTRU may transmit initial access Msg1 and/or Msg3 using resource associated with the selected second SSB. For example, the WTRU may select a RACH preamble associated with the selected second SSB and/or transmit the preamble (e.g., Msg1). In examples, if the WUS response indication includes an UL grant, the WTRU may transmit Msg3 (e.g., RRC message) based on the selected second SSB (e.g., new beam).

In examples, the WTRU may be configured with an SSB muting pattern which may be aligned with CSI-RS transmission. In examples, the WTRU may determine the presence/absence of CSI-RS resource based on the presence/absence of an associated SSB and/or beam in the configured SSB muting pattern. The WTRU may skip one or more measurements of muted CSI-RS based on the configured SSB muting pattern, for example. If the measured unmuted CSI-RS are below an RSRP threshold, the WTRU may transmit a Cell WUS indication to request activation of the muted CSI-RS and/or to request changing the Cell DTX activity mode/configuration (e.g., cell DTX pattern). The WTRU may monitor for new CSI-RS resource over a time window/duration associated with WUS response based on (e.g., after) transmitting cell WUS indication. Upon performing measurements on the detected SSBs/CSI-RS and/or selecting a beam, the WTRU may select a RACH preamble associated with the selected beam for transmitting Msg1 during initial access, for example.

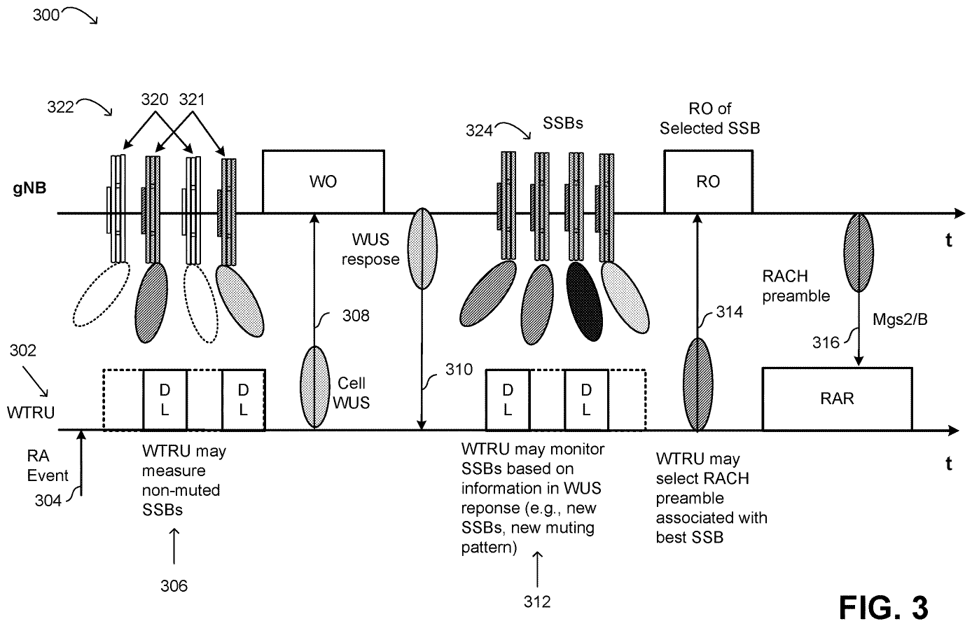

FIG. 3 depicts a system diagram 300 illustrating an example of a WTRU 302 that may be configured to achieve DL synchronization with non-muted SSBs 321 based on an SSB muting pattern 322. For example, the SSB muting pattern 322 may comprise muted SSBs 320 and non-muted SSBs 321. The WTRU 302 may determine to transmit a Cell WUS indication 308, for example, when triggered by an RA event 304. The WTRU 302 may determine to transmit the Cell WUS indication 308, using resources associated with a non-muted SSB (e.g., one of the non-muted SSBs 321), if the non-muted SSBs 321 are unsuitable, for example. The WTRU 302 may receive information on new SSBs 324 to be triggered and/or an update to the SSB muting pattern 322, for example, in a WUS response 310. The WTRU 302 may select a new SSB of the new SSBs 324, indicated in the WUS response 310, for transmitting a random access message (e.g., the RACH preamble (Msg1). For example, the WTRU 302 may transmit an initial access message using one or more RACH resources associated with the selected new SSB of the new SSBs 324.

In examples, the WTRU 302 may perform one or more of the following.

The WTRU 302 may receive configuration information. The configuration information may include one or more of the following. The configuration information may include an SSB muting pattern (e.g., periodicity, start offset of SSB burst, number of SSBs per burst). For example, an SSB muting pattern may include 8 non-muted SSBs per burst with periodicity 20 ms or 4 non-muted SSBs per burst with periodicity 40 ms. For example, an SSB muting pattern may indicate which SSBs (e.g., which SSB indexes) are muted (or not muted) in one or more (e.g., each) burst(s), where the SSBs available (e.g., not muted) in consecutive bursts may be the same or may be different. For example, the SSB muting pattern may indicate which SSBs are muted or not muted in each of a plurality of SSB bursts. The non-muted SSBs in consecutive bursts may be the same. The SSB muting pattern may be a pattern from a set of configured patterns and/or may be indicated by a pattern ID and/or index. The configuration information may include one or more Cell WUS resources (e.g., mapping between with non-muted SSBs and WUS resources). The configuration information may include a RSRP threshold.

The WTRU 302 may receive an indication and/or configuration information indicating that SSB muting is enabled. For example, the WTRU 302 may receive an SSB muting pattern ID. The SSB muting pattern ID may be received when the SSB muting is enabled (e.g., in the same message, DCI, and/or MAC-CE).

At 306, the WTRU 302 may perform one or more measurements on the available non-muted SSBs 321 within the SSB muting pattern 322, for example, when triggered by an event (e.g., desire/need to connect, resume a connection, and/or transmit data). The triggering event may include the RA event 304. For example, the WTRU 302 may measure a first set of non-muted SSBs 321 associated with the SSB muting pattern 322. The WTRU 302 may be configured to trigger the measurement of the first set of non-muted SSBs 321 based on the RA event 304.

The WTRU 302 may determine that one or more measurements of each of the first set of non-muted SSBs 321 are below the RSRP threshold. If the one or more of the RSRP measurements of the non-muted SSBs are below RSRP threshold, for example, the WTRU 302 may select a first SSB from among the non-muted SSBs 321 (e.g., based on one or more measurements). If the one or more of the RSRP measurements of the non-muted SSBs 321 are below RSRP threshold, for example, the WTRU 302 may transmit (e.g., send) a Cell WUS 308 (e.g., cell WUS indication). For example, the WTRU 302 may send the cell WUS indication 308 based on the determination that measurements of each of the first set of non-muted SSBs 321 are below the RSRP threshold. The WTRU 302 may send the cell WUS indication 308 using one or more resources associated with the selected non-muted SSB. For example, the cell WUS indication 308 may be sent using resources associated with an SSB of the first set of non-muted SSBs 321. For example, Cell WUS indication 308 may be intended to wake up one or more (e.g., some) muted SSBs (e.g., adjacent to the selected non-muted SSB), for example, such as the muted SSBs 320.

The WTRU 302 may receive a WUS response 310. The WUS response 310 may be received subsequent to sending the cell WUS indication 308. At 312, the WTRU 302 may monitor SSBs 324 based on information in the WUS response 310 (e.g., new SSBs, new muting pattern, etc.). The WTRU 302 may measure the second set of non-muted SSBs (e.g., the SSBs 324). For example, if the one or more of the RSRP measurements of the non-muted SSBs 321 are below RSRP threshold the WTRU 302 may receive the WUS response 310 via one or more resources associated with the selected non-muted SSB. The WUS response 310 may include one or more of the following: an index to SSBs (e.g., other SSBs that may have been activated and/or may now be available), an indication of disabling of muting, an UL grant, a NES state ID, a new muting pattern (e.g., pattern ID). The WUS response 310 may indicate a second set of non-muted SSBs (e.g., such as the SSBs 324). The indication of the second set of non-muted SSBs may include one or more of an indication of one or more newly available SSBs and/or a second SSB muting pattern. If the one or more of the RSRP measurements of the non-muted SSBs 321 are below RSRP threshold, the WTRU 302 may monitor for SSBs based on the information in the WUS response 310 (e.g., newly available SSBs, new muting pattern). If the one or more of the RSRP measurements of the non-muted SSBs 321 are below the RSRP threshold, for example, the WTRU 302 may select a second SSB (e.g., a new beam) from the monitored SSBs 324 (e.g., based on one or more measurement(s). For example, the selected SSB may be associated with a measured RSRP that is a highest RSRP associated with the second set of SSBs 324. If the one or more of the RSRP measurements of the non-muted SSBs 321 are below the RSRP threshold, the WTRU 302 may transmit a random access message 314 (e.g., a RACH Msg1 and/or Msg3) based on (e.g., using a resource associated with) the selected second SSB (e.g., new beam). For example, the WTRU 302 may select a RACH preamble associated with the selected second SSB (e.g., new beam, best SSB) and/or may transmit the random access message 314, for example, preamble (e.g., Msg1). The random access message may be associated with initial access and establishment of a connection with the network (e.g., as described herein). The WTRU 302 may select an SSB from the second set of non-muted SSBs 324 based on the measurements of the second set of non-muted SSBs 324. The selected SSB may be for transmission of the random access message 314 (e.g., a RACH preamble). If the WUS response 310 includes an UL grant, the WTRU 302 may transmit the random access message 314 (e.g., an RRC message such as Msg3) based on the selected second SSB (e.g., new beam). For example, the WTRU 302 may transmit an initial access message using one or more RACH resources associated with the selected SSB. The WTRU 302 may receive a random access message 316 (e.g., Msg2/B).

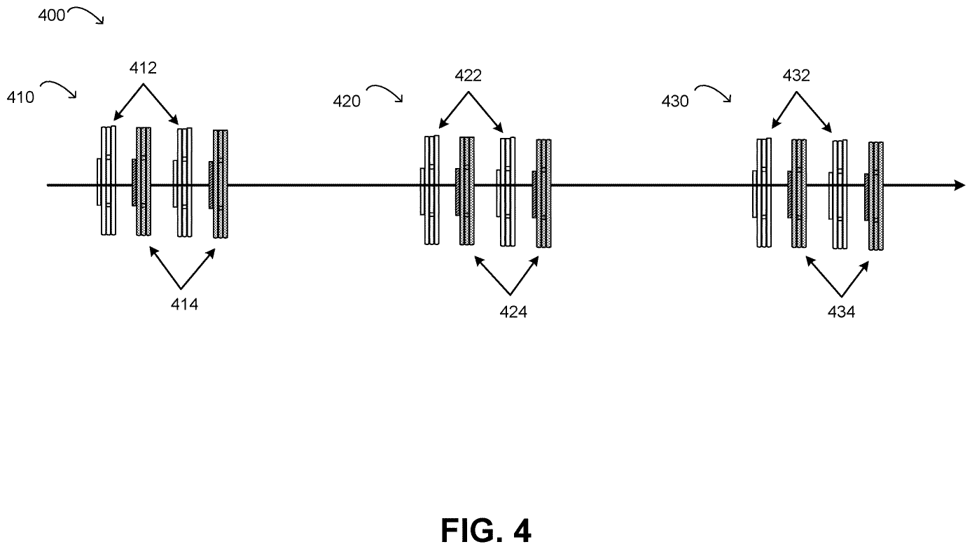

FIG. 4 depicts an example expansion of a SSB muting pattern 400. The SSB muting pattern 400 may indicate which SSBs (e.g., SSB indexes) are muted or not muted in each of a plurality of SSB bursts 410, 420, 430. In examples, the muted or non-muted SSBs in each of a plurality of SSB bursts may be identified based on the indexes/IDs associated with the respective muted or non-muted SSBs. For example, a first SSB burst 410 may include a plurality of muted SSBs 412 and a plurality of non-muted SSBs 414. The muted SSBs 412 and the non-muted SSBs 414 may be in a pattern (e.g., the SSB muting pattern 400). A second SSB burst 420 may include a plurality of muted SSBs 422 and a plurality of non-muted SSBs 424. The muted SSBs 422 and the non-muted SSBs 424 may be in a pattern (e.g., the SSB muting pattern 400). A third SSB burst 430 may include a plurality of muted SSBs 432 and a plurality of non-muted SSBs 434. The muted SSBs 432 and the non-muted SSBs 434 may be in a pattern (e.g., the SSB muting pattern 400). Although the non-muted SSBs 414, 424, 434 in consecutive SSB bursts 410, 420, 430 are the same, it should be appreciated that the non-muted SSBs 414, 424, 434 in consecutive bursts 410, 420, 430 may be different.

Systems, methods, and apparatuses are provided herein with respect to a WTRU that may transmit a Cell WUS indication to request to change an SSB muting pattern.

In examples, the WTRU may determine to transmit a Cell WUS indication to request to change an existing SSB muting pattern and/or for activating a new SSB muting pattern (e.g., based on DL synchronization achieved with the non-muted SSBs. One or more embodiments may be applied when an SSB muting pattern is applied by a cell operating in an NES state (e.g., cell DTX) where (e.g., only) a subset and/or limited number of SSBs are transmitted. One or more embodiments may be applied by the WTRU when determining that a configured and/activated SSB muting pattern is determined to be unsuitable, for example.

In examples, the WTRU may receive configuration information, via one or more of the following: SIB, RRC signaling, cell activity indication, and/or DCI and/or MAC CE. The configuration information may include one or more of the following. The configuration information may include a set of two or more SSB muting patterns. SSB muting pattern configuration may include, for example, for one or more (e.g., each) pattern(s) the number of SSBs per burst, periodicity per burst, and/or which SSBs are transmitted in one or more (e.g., each) burst(s). For example, an SSB muting pattern may include 8 SSBs per burst with a periodicity of 20 ms (e.g., an SSB burst may be receive by the WTRU every 20 ms) and/or another SSB muting pattern may include 4 SSBs per burst with periodicity of 40 ms. The configuration information may include an indication that a first SSB muting pattern from the set of SSB muting patterns is activated. The configuration information may include a RSRP threshold. The configuration information may include one or more delay threshold values. For example, a delay threshold value may be associated with the delay for monitoring, measuring, and/or selecting one or more SSBs/beams. The delay threshold may be applied when determining whether an SSB muting pattern is suitable and/or may be changed.

In examples, the WTRU may monitor for non-muted SSBs according to a configured first SSB muting pattern when detecting one or more triggering events/conditions (e.g., detection of a RA event). The WTRU may perform one or more measurements on the detected one or more non-muted SSBs (e.g., SSB beams) in the first SSB muting pattern. The WTRU may select a non-muted SSB based on the RSRP measurements (e.g. the WTRU may select a non-muted SSB with the heist RSRP).

If the RSRP of the selected non-muted SSBs is above a RRSP threshold value, the WTRU may transmit a RACH preamble associated with the selected non-muted SSB for initial access and/or establishing connection with the network. For example, the WTRU may transmit an initial access message using one or more RACH resources associated with the selected SSB. Additionally or alternatively, if the RSRP of the selected non-muted SSBs is less than a RRSP threshold value, the WTRU may determine a second SSB muting pattern based on one or more of the following. The WTRU may determine a second SSB muting pattern based on the number of SSBs per burst in one or more (e.g., each) SSB muting pattern. For example, the WTRU may determine a second SSB muting pattern that may have certain number of SSBs per burst that is above a threshold value and/or higher than the number of SSBs per burst in the first SSB muting pattern. The WTRU may determine a second SSB muting pattern based on the periodicity associated with one or more (e.g., each) SSB muting pattern. For example, the WTRU may determine a second SSB muting pattern that may have a periodicity of an SSB burst that is above or below a threshold value and/or higher than the periodicity of the first SSB muting pattern. The WTRU may determine a second SSB muting pattern based on which SSBs are transmitted in one or more (e.g., each) SSB muting pattern. For example, the WTRU may determine a second SSB muting pattern that may have a certain set of SSBs and/or density of SSBs that may not be available in the first SSB muting pattern. The WTRU may determine a second SSB muting pattern based on the time to the next burst of the activated SSB muting pattern. For example, the WTRU may determine a second SSB muting pattern based on whether the time and/or delay to the next SSB burst in the first SSB muting pattern is greater than a delay threshold and/or the time and/or delay to the next SSB burst in the second SSB muting pattern is less than another delay threshold.

In examples, the WTRU may transmit the Cell WUS indication to the network, upon determining a second SSB muting pattern. Such Cell WUS indication may be transmitted by the WTRU using one or more resources and/or the spatial filter associated with the selected non-muted SSB, for example. Such Cell WUS indication may be used for requesting the network and/or for providing preference information to the network on any one or more of the following: request to change/deactivate the first SSB muting pattern, request to activate the second SSB muting pattern (e.g. ID/index associated with the second SSB muting pattern) and/or request to transition to a non-NES state. Such Cell WUS indication may be transmitted during a WUS occasion associated with the non-muted SSB configured in the WTRU, for example.

In examples, the WTRU may receive a WUS response from the network, upon transmitting the Cell WUS indication. The WTRU may start a WUS response timer m symbols/slots (e.g. m=1) based on (e.g., after) transmitting the Cell WUS indication during a WUS occasion. The WTRU may monitor for a WUS response indication while the WUS response timer is running, for example. The WUS response may be received in a WTRU specific signaling and/or group-common signaling, for example. The WUS response may be received via the one or more resources associated with the non-muted SSB (e.g., via the SSB/beam used by the WTRU for transmitting the cell WUS indication).

The WUS response indication may include one or more of the following: indication of the activation of the second SSB muting pattern and/or another/third SSB muting pattern (e.g., pattern ID/index), indication of new SSBs in the first and/or second SSB muting pattern that may have been activated and/or may now be available (e.g., index(es) associated with one or more new SSBs), and/or indication of disabling of the first SSB muting pattern.

In examples, the WTRU may monitor for a set of one or more non-muted SSBs in the second SSB muting pattern and/or third SSB muting pattern, based on the information received in the WUS response indication. The WTRU may perform one or more measurements on the one or more non-muted SSBs. The WTRU may (e.g., then) select a non-muted SSB (e.g., new SSB beam) in the second and/or third SSB muting pattern based on one or more measurements (e.g., L1 RSRP) and/or using a criteria associated with the one or more measurements (e.g., RSRP measurements of the selected non-muted SSB is above a threshold and/or highest among the detected non-muted SSBs in the second and/or third SSB muting pattern).

The WTRU may transmit initial access Msg1 and/or Msg3 using resource associated with the selected non-muted SSB. For example, the WTRU may select a RACH preamble associated with the selected non-muted SSB and/or may transmit the preamble (e.g., Msg1). In examples, if the WUS response indication includes an UL grant, the WTRU may transmit Msg3 (e.g., RRC message) based on the selected non-muted SSB. For example, the WTRU may transmit an initial access message using one or more RACH resources associated with the selected non-muted SSB.

In examples, the WTRU may perform one or more of the following.

The WTRU may receive configuration information. The configuration information may include a set of two or more SSB muting patterns. SSB muting pattern configuration may include, for example, for one or more (e.g., each) pattern the number of SSBs per burst, periodicity per burst, and/or which SSBs are transmitted in one or more (e.g., each) burst. For example, an SSB muting pattern may include 8 SSBs per burst with periodicity 20 ms and/or another SSB muting pattern may include 4 SSBs per burst with periodicity 40 ms. The configuration information may include an indication that a first SSB muting pattern from the set of SSB muting patterns is activated. The configuration information may include a RSRP threshold. The configuration information may include one or more delay threshold values.

The WTRU may perform one or more measurements on one or more non-muted SSBs based on the first (e.g., activated) SSB muting pattern, for example, when triggered by an RA event.

The WTRU may select a non-muted SSB based on the one or more measurements (e.g., non-muted SSB with the highest RSRP).

If the RSRP of the selected non-muted SSB is less than the RSRP threshold, the WTRU may determine a second SSB muting pattern based on one or more of the following. The WTRU may determine a second SSB muting pattern based on the number of SSBs per burst in one or more (e.g., each) SSB muting pattern. he WTRU may determine a second SSB muting pattern based on the periodicity associated with one or more (e.g., each) SSB muting pattern. he WTRU may determine a second SSB muting pattern based on which SSBs are transmitted in one or more (e.g., each) burst in one or more (e.g. each) muting pattern. he WTRU may determine a second SSB muting pattern based on the time to the next burst of the activated SSB muting pattern (e.g., whether the time to the next burst is greater than a delay threshold). If the RSRP of the selected non-muted SSB is less than the RSRP threshold, the WTRU may transmit a Cell WUS. The Cell WUS may indicate the request to activate the second SSB muting pattern. If the RSRP of the selected non-muted SSB is less than the RSRP threshold, the WTRU may receive a WUS response. The WUS response may indicate the activation of the second SSB muting pattern and/or another SSB muting pattern (e.g., ID of the activated SSB muting pattern). If the RSRP of the selected non-muted SSB is less than the RSRP threshold, the WTRU may perform one or more measurements on one or more non-muted SSBs based on the second SSB muting pattern and/or other SSB muting pattern indicated by the WUS response. If the RSRP of the selected non-muted SSB is less than the RSRP threshold, the WTRU may select a non-muted SSB (e.g., based on one or more measurements). If the RSRP of the selected non-muted SSB is less than the RSRP threshold, the WTRU may transmit a RACH preamble associated with the selected SSB. For example, the WTRU may transmit an initial access message using one or more RACH resources associated with the selected SSB.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1.-20. (canceled)

21. A wireless transmit/receive unit (WTRU) comprising:
a processor configured to:
receive configuration information comprising one or more of a synchronization signal block (SSB) muting pattern, one or more cell wake up signal (WUS) resources, or a reference signal received power (RSRP) threshold;
measure a first set of non-muted SSBs associated with the SSB muting pattern;
determine that measurements of each of the first set of non-muted SSBs are below the RSRP threshold;
send a cell WUS indication based on the determination that the measurements of each of the first set of non-muted SSBs are below the RSRP threshold;
receive a WUS response that indicates a second set of non-muted SSBs;
measure the second set of non-muted SSBs;
select an SSB from the second set of non-muted SSBs based on the measurements of the second set of non-muted SSBs; and
transmit an initial access message using one or more random access channel (RACH) resources associated with the selected SSB.

2. The WTRU of claim 21, wherein the first set of non-muted SSBs or the second set of non-muted SSBs are transmitted in a non-uniform pattern, and wherein the SSB muting pattern comprises one or more of a periodicity, a start offset of an SSB burst, or number of SSBs per burst.

23. The WTRU of claim 21, wherein the cell WUS resources comprise a mapping associated with non-muted SSBs and WUS resources.

24. The WTRU of claim 21, wherein the SSB muting pattern indicates which SSBs are muted or not muted in each of a plurality of SSB bursts, and wherein the non-muted SSBs in consecutive bursts are the same.

25. The WTRU of claim 21, wherein the WUS response is received subsequent to sending the cell WUS indication.

26. The WTRU of claim 21, wherein the processer is configured to trigger the measurement of the first set of non-muted SSBs based on a random access (RA) event.

27. The WTRU of claim 21, wherein the cell WUS indication is sent using resources associated with an SSB of the first set of non-muted SSBs.

28. The WTRU of claim 21, wherein the selected SSB is associated with a measured RSRP that is a highest RSRP associated with the second set of SSBs.

29. The WTRU of claim 21, wherein the initial access message is sent based on the selected SSB, wherein the initial access message is associated with initial access and establishment of a connection with the network.

30. The WTRU of claim 21, wherein the indication of the second set of non-muted SSBs comprises one or more of an indication of one or more newly available SSBs or a second SSB muting pattern.

31. A method performed by a wireless transmit/receive unit (WTRU), the method comprising:
receiving, configuration information, the configuration comprising one or more of: a synchronization signal block (SSB) muting pattern, one or more cell wake up signal (WUS) resources, or a reference signal received power (RSRP) threshold;
measuring a first set of non-muted SSBs associated with the SSB muting pattern;
determining that one or more measurements of each of the first set of non-muted SSBs are below the RSRP threshold;
sending a cell WUS indication based on the determination that the one or more measurements are below the RSRP threshold;
receiving a WUS response that indicates a second set of non-muted SSBs;
measuring the second set of non-muted SSBs;
selecting an SSB from the second set of non-muted SSBs based on the measurements of the second set of non-muted SSBs, wherein the SSB is selected for transmission of a random access channel (RACH) preamble; and
transmitting an initial access message using one or more random access channel (RACH) resources associated with the selected SSB.

32. The method of claim 31, wherein the first set of non-muted SSBs or the second set of non-muted SSBs are transmitted in a non-uniform pattern, and wherein the SSB muting pattern comprises one or more of: periodicity, start offset of an SSB burst, or number of SSBs per burst.

33. The method of claim 31, wherein the cell WUS resources comprise mapping associated with non-muted SSBs and WUS resources.

34. The method of claim 31, wherein the SSB muting pattern indicates which SSBs are muted or not muted in each SSB burst, and wherein the non-muted SSBs in consecutive bursts are the same.

35. The method of claim 31, wherein the WUS response is received subsequent to sending the cell WUS indication.

36. The method of claim 31, wherein the measuring of the first set of non-muted SSBs is triggered by a random access (RA) event.

37. The method of claim 31, wherein the cell WUS indication is sent using resources associated with an SSB of the first set of non-muted SSBs.

38. The method of claim 31, wherein the selected SSB is associated with a measured RSRP that is a highest RSRP associated with the second set of SSBs.

39. The method of claim 31, wherein the initial access message is sent based on the selected SSB, wherein the initial access message is associated with initial access and establishment of a connection with the network.

40. The method of claim 31, wherein the indication of the second set of non-muted SSBs comprises one or more of an indication of one or more newly available SSBs or a second SSB muting pattern.
